(19) United States
(12) Patent Application Publication
(10) Pub. No.: US 2017/0085371 A1
(43) Pub. Date: Mar. 23, 2017

(54) SYSTEM AND METHOD FOR AN ENHANCED XOR CIPHER THROUGH EXTENSIONS

(71) Applicant: SECURE CHANNELS SA, Vaud (CH)

(72) Inventor: Robert Coleridge, Bellingham, WA (US)

(21) Appl. No.: 15/082,853

(22) Filed: Mar. 28, 2016

Related U.S. Application Data
(60) Provisional application No. 62/144,027, filed on Apr. 7, 2015.

(51) Int. Cl. H04L 9/06; H04L 9/08

(52) U.S. Cl. CPC H04L 9/0662; H04L 9/0861

(57) ABSTRACT

A system and method for providing a rapid, yet highly secure cryptographic technique, to provide enhanced protection for digital data. At least one random value and Deterministic Sequence Generator (DSG) seeds are mathematically processed to create an initialization value (IV). The initialization value (IV) is mathematically processed with a user key to generate a set of initial DSG vectors. The initial DSG vectors are then inputted into a DGS and, using the initial DSG vectors, the DSG creates an additive table and a substitution table. An initial internal working key is generated from the user key and the initial DSG vectors. An addition, an XOR and a substitution operation is applied to each byte of plaintext data in combination with the internal working key to enable the cipher to quickly and effectively encrypt the plaintext data. Once encrypted, the encrypted data may be stored in memory for subsequent use and/or transmitted to another party. Decryption of the encrypted data may be performed by applying the inverse of the above process.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS-REFERENCE TO RELATED APPLICATIONS

This is a non-provisional application, which claims the benefit of U.S. Provisional Application No. 62/144,027, filed Apr. 7, 2015, which is hereby incorporated by reference in its entirety.

### BACKGROUND

Technical Field

The disclosed technology generally relates to cryptographic techniques and, more particularly, to cryptographic techniques that are both rapid and highly secure.

Description of the Related Art

Today, digital data has become an ever increasing component of everyday lives. Digital data is used to communicate, complete financial transactions and to store personal information. As such digital data becomes a more significant component in today's world, the ability to protect such digital data from improper usage by third parties becomes imperative. To provide such protection, users frequently turn to cryptography.

In one form, cryptography is the art and science of preparing, transmitting and reading messages in a form intended to prevent the message from being read by those not privy to secrets associated with the form. Cryptography is practiced in and widely appreciated for a wide array of applications, including gaming, computer security, healthcare information security, banking information security, military communications, mathematics, intellectual property protection and many others.

But frequently, there is an inequity with many cryptographic techniques. Some ciphers are very strong, but they are very slow and time consuming to implement. This makes such ciphers less desirable in today's fast paced technology world. Other ciphers are very fast, but they provide less significant protection and are more prone to hacking. Such lesser protection, leaves valuable digital data vulnerable to attack and confiscation by unauthorized users.

Accordingly, there has been a long felt need for a cryptographic cipher that can quickly provide very strong security for protecting today's digital data. The currently disclosed cryptographic technology fulfils this and other needs.

### BRIEF SUMMARY

Briefly, and in general terms, various embodiments are directed to cryptographic techniques. More particularly, the various embodiments are directed to a fast, yet highly secure cryptographic technique referred to herein as an Enhanced XOR CIpher Through Extensions (EXCITE).

In one embodiment, the EXCITE technique uses a random value (and optionally additional random values chosen by a user) that is mathematically processed with one or more Deterministic Sequence Generator (DSG) seeds (also random numbers) to create an initialization value (IV). In some embodiments, while any random value may be used as the DSG seeds, it is desired that the DSG seeds are mathematically congruent to the formulas and algorithms used in the DSG.

The initialization value (IV) is mathematically processed with a user key to generate a set of initial DSG vectors. The initial DSG vectors are input into the DSG.

The DSG is a Deterministic Sequence Generator that produces a repeatable sequence of random numbers given a fixed set of initial parameters. The DSG, using a processor, generates an additive table, a substitution table and an initial internal working key. Applying an addition, an XOR and a substitution operation to each byte of plaintext data in combination with the internal working key enables the EXCITE technique to quickly and effectively encrypt the plaintext data. The internal working key will generally be at least twice the length of the user key, but any length key may be used.

During encryption, whenever a working key is exhausted, a new working key is generated using the current DSG vectors. This process of creating new working keys and applying the addition, XOR and substitution operations continues until all the plaintext data has been encrypted and all iterations of encryption have completed. The order of the addition, XOR and substitution operations can be altered during a given cycle of encryption and/or the processing operations can be altered between different encryption iterations. Generally, all the data processing is done by the processor at a byte level.

Once encrypted, the encrypted data may be stored in a memory or other appropriate device or location for subsequent use and/or transmitted to another party. Upon receipt, the receiving party can decrypt the encrypted data using the inverse EXCITE process described above.

During decryption, the EXCITE technique must use the same initial variables in the DSG as used in the encryption process. In this regard, the EXCITE technique accesses the initialization value (IV) from a memory or other appropriate device or location. Optionally, the EXCITE technique uses the random value (and optionally any of the additional random values chosen by a user during encryption) and mathematically processes the random value(s) with one or more DSG seeds (also random numbers) to create the initialization value (IV) used during encryption. Alternatively, the initialization value (IV) may be embedded into the data stream itself. The initialization value (IV) is mathematically processed with the user key to generate the set of initial DSG vectors. The initial DSG vectors are input into the DSG.

The DSG, using a processor, generates a subtractive table, an inverse substitution table and an initial internal working key. Applying a substitution, an XOR and a subtraction operation to each byte of encrypted text in combination with the internal working key enables the EXCITE technique to quickly and effectively decrypt the encrypted text. Whenever, during decryption process, a working key is exhausted, a new working key is generated using the current DSG vectors. This process of creating new working keys and applying the subtraction, XOR and substitution operations continues until all the encrypted text has been decrypted and all iterations of decryption have completed. As with encryption, the order of the substitution, XOR and subtraction operations can be altered during a given cycle of decryption and/or the processing operations can be altered between different decryption iterations, but the same order as used during the encryption process must be used during the decryption process.

Other features will become apparent from the following detailed description, taken in conjunction with the accompanying drawings, which illustrate by way of example, the features of the various embodiments.

### BRIEF DESCRIPTION OF THE SEVERAL VIEWS OF THE DRAWINGS

FIG. 1 is a general block diagram of a system configured for use in performing the disclosed rapid and highly secure cryptographic technique Enhanced XOR CIpher Through Extensions (EXCITE).

FIGS. 2A and 2B show a logic flow diagram of a method of encrypting plaintext data using the EXCITE technique.

FIGS. 3A and 3B show a logic flow diagram of a method of decrypting an encrypted text using the EXCITE technique.

### DETAILED DESCRIPTION

Each of the features and teachings disclosed herein can be utilized separately or in conjunction with other features and teachings to provide an Enhanced XOR CIpher Through Extensions (EXCITE).

The presently disclosed cryptographic technique, EXCITE, provides a fast, yet highly secure system and method for protecting digital data, EXCITE combines the advantages of a fast exclusive OR (XOR) cipher with the strength and protection afforded by a one-time pad (OTP). More particularly, EXCITE combines the best of these two techniques, i.e. speed and strength, with a third component, namely a Deterministic Sequence Generator (DSG), to produce a rapid, yet highly secure cipher.

Generally, in cryptography the simple XOR operation is used to create an XOR cipher. With this operation, a string of text can be encrypted by applying XOR to every character using a given key. To decrypt the output, merely reapplying the XOR function with the key will remove the cipher.

For example, the string “Wiki” (01010111 01101001 01101011 01101001 in 8-bit ASCII) can be encrypted with the repeating key 11110011 as follows:

$$XOR = \frac{\begin{matrix}01010111 & 01101001 & 01101011 & 01101001 \\ 11110011 & 11110011 & 11110011 & 11110011\end{matrix}}{\begin{matrix}10100100 & 10011010 & 10011000 & 10011010\end{matrix}}$$

And conversely, for decryption:

$$XOR = \frac{\begin{matrix}10100100 & 10011010 & 10011000 & 10011010 \\ 11110011 & 11110011 & 11110011 & 11110011\end{matrix}}{\begin{matrix}01010111 & 01101001 & 01101011 & 01101001\end{matrix}}$$

The XOR operator is frequently a component in more complex ciphers. By itself, however, using a constant repeating key, a simple XOR cipher can trivially be broken by analysing the frequency of the results and therein lays the weakness of an XOR cipher. If the content of any message can be guessed or otherwise known then the key can be revealed. Its primary merit is that it is simple to implement and, on modern CPUs, extremely fast and computationally inexpensive. A simple repeating XOR cipher (i.e., using the same key for XOR operation on the entire data) is, therefore, sometimes used for hiding information in cases where no particular security is required.

The key that is used in an XOR cipher generally must equal or exceed the size of the data to be encrypted and, once used that key can never be used again. Therefore, if the key is random and is at least as long as the message, the XOR cipher is much more secure than when there is key repetition within a message. However, for large data, the key size requirement of the XOR cipher requires a larger memory to execute such an encryption technique. Moreover, the requirement of non-reusability of the key further limits the XOR cipher's practicality. Accordingly, the XOR cipher generally is not practical for any large data or for repeated usage of the same key.

Similarly, a one-time pad (OTP) is a technique in which a key that is generated randomly can be used only once to encrypt a message. The message is decrypted by the receiver of the encrypted message using a matching OTP and key. Messages encrypted with such keys based on randomness have the advantage that there is theoretically no way to “break the code” by analysing a succession of messages. Each encryption is unique and, therefore, bears no relation to the next encryption. Consequently, patterns cannot be detected or determined from the encryption process.

When using an OTP, the decrypting party must have access to the same key used to encrypt the message. Accordingly, these issues raise the problem of how to get the key to the decrypting party safely and how to keep both keys secure. Thus, secure key exchange is required to successfully use an OTP.

OTPs have sometimes been used when both parties in the cryptography process start out at the same physical location and then separate, each with knowledge of the keys in the OTP. The key used in an OTP is called a secret or private key because if it is revealed, the messages encrypted with it can easily be deciphered.

OTPs figured prominently in secret message transmission and espionage before and during World War II and in the Cold War era. On the Internet, the difficulty of securely controlling the keys led to the invention of public key cryptography.

In use, an OTP is created by generating a string of characters or numbers that will be at least as long as the longest message that may be sent. This string of values is generated in a random fashion, for example, by someone pulling numbered balls out of a lottery machine or by using a computer program with a random number generator. The values are written down on a pad or any device that someone can read or use. The pads are given to anyone who may likely send or receive a message. Typically, a pad may be issued as a collection of keys, one for each day in a month. For example, one key expiring at the end of each day or as soon as it has been used.

When a message is to be sent, the sender uses the secret key to encrypt each character, one at a time. If a computer is used, each bit in the character (which is usually eight bits in length) is exclusively OR'd (XOR'd) with the corresponding bit in the secret key. In some embodiments, in the case of a one-time pad, the encryption algorithm is simply the XOR operation. Although, there is some concern about how truly random the key is, it is sometimes combined with another algorithm such as an MD5, i.e. a message-digest algorithm.

In one embodiment, such encryption can be described as a “100% noise source” and used to mask the message. Only the sender and receiver have the means to remove the noise. Again, once the one-time pad is used, it can't be reused. If it is reused, someone who intercepts multiple messages could begin to compare them for similar coding for words that may possibly occur in both messages.

The very nature of an OTP, if implemented correctly, guarantees mathematical un-breakability. The problem with this cipher is that it is very cumbersome to use and is very slow to process. It also requires that all recipients of encrypted data have access to the same set of ‘pads’ thus creating, rather than alleviating, a major security threat. This cumbersomeness and the security issues prevents an OTP from being widely used or implemented outside of strict situational instances, such as the military where the need for un-breakability outweighs the awkwardness of usage.

However, when these two ciphers (XOR and OTP) are combined with a Deterministic Sequence Generator (DSG), they create a very fast, yet highly secure cipher with all the advantages of speed and security, without the disadvantages associated with large data sets, repeated usage of the same key (as in an XOR cipher) or the cumbersomeness and slow speed of an OTP cipher.

More particularly, the Deterministic Sequence Generator (DSG) is an algorithm for generating a sequence of numbers whose properties approximate the properties of sequences of random numbers. As used herein, the term deterministic is defined as an algorithm, model, procedure, process, and the like, whose resulting behaviour is entirely determined by its initial state and inputs, and which is not random or stochastic. The DSG generated sequence is not truly random, because it is completely determined by a relatively small set of initial values, called DSG seeds (which may include truly random values). Given the same seeds, the DSG always creates the same sequence. Although sequences that are closer to truly random can be generated using hardware based random number generators, DSGs are important in cryptography practice for their speed of number generation and their reproducibility.

During an encryption and decryption process, any deterministic number generator (DSG) may be used, so long as both the sender and the recipient are using the same DSG. By way of example and not by way of limitation, one preferred embodiment of a DSG is a Multiply With Carry (MWC), as shown below.

An MWC sequence is based on an arithmetic modulo a base b, usually b=2³², because arithmetic modulo of that b is automatic in most computers. However, sometimes a base such as b=2³²−1 is used, because the arithmetic for modulus 2³²−1 requires only a simple adjustment from that used for 2³², and theory for MWC sequences based on modulus 2³² has some nagging difficulties avoided by using b=2³²−1.

In its most common form, a lag-r MWC generator requires a base b, a multiplier a, and a set of r+1 random seed values, consisting of r residues of b,

x₀,x₁,x₂, . . . ,xᵣ₋₁,

and an initial carry cᵣ₋₁<a.

The lag-r MWC sequence is then a sequence of pairs xₙ, cₙ determined by

$${x}_{n} = ( {ax}_{n \text{-} r} + {c}_{n \text{-} 1} ) mod b , \\ {c}_{n} = ⌊ \frac{{ax}_{n \text{-} r} + {c}_{n \text{-} 1}}{b} ⌋ , \\ n \geq r ,$$

and the MWC generator output is the sequence of x's,

xᵣ,xᵣ₊₁,x_{r+2, . . .}

The period of a lag-r MWC generator is the order of b in the multiplicative group of numbers modulo ab^{r}−1. It is customary to choose a's so that p=ab^{r}−1 is a prime for which the order of b can be determined. Because 2 is a quadratic residue of numbers of the form 8k±1, b=2³² cannot be a primitive root of p=ab^{r}−1. Therefore, there are no MWC generators for base 2³² that have the maximum possible period, one of the difficulties that use of b=2³²−1 overcomes. In general, in case of a DSG, given the same set of inputs, the DSG will always output the same random number sequence.

Briefly, the EXCITE technique performs the following steps to encrypt plaintext data rapidly and with high security.

A deterministic Sequence Generator (DSG) is used to generate random numbers to encrypt the plaintext data in combination with XOR and OTP ciphers.

In operation, the EXCITE technique uses a random value (and optionally additional random values chosen by a user) that is mathematically processed with one or more DSG seeds (also random numbers) to create an initialization value (IV). Note that once chosen, the DSG seeds never change throughout the given encryption/decryption process. The initialization value (IV) is mathematically processed with a user key to generate a set of initial DSG vectors. As used herein, mathematically processed can mean applying any mathematical operation to the numbers to essentially merge or combine the numbers.

The initial DSG vectors are input into the DSG. The DSG, using a processor, generates an additive table, a substitution table and an initial internal working key (the working key being generated from the user key). Applying an addition, an XOR and a substitution operation to each byte of plaintext data in combination with the internal working key enables the EXCITE cipher to quickly and effectively encrypt the plaintext data. Each time any values are generated, e.g., for each of the tables and/or the internal working key, the DSG vectors will change and the DSG will provide the next random number from a sequence of random numbers generated based upon such DSG vectors.

The order of the addition, XOR and substitution operations can be altered during a given cycle of encryption (e.g., by sensing a trigger event, e.g. exceeding twice a determined noise threshold) and/or the processing operations can be altered between different encryption iterations. Of course, the same processing order can be used throughout a single encryption iteration or among the plurality of iterations. However, the same order of operations must the used during decryption as well.

The internal working key will generally be at least twice the length of the user key, but any length key may be used. Each working key is used to process n bytes of plaintext data, corresponding to a working key length of n bytes. Once a working key is exhausted, i.e., it has run its length, a new working key of n bytes is generated using the current DSG vectors.

This process of creating new working keys and applying the addition, XOR and substitution operations continues until all the plaintext has been encrypted and all iterations of encryption have completed.

Optionally, noise may be applied during the encryption process to enhance the strength of the encrypted data. In this event, a noise threshold is determined. If a byte of data exceeds the threshold, then noise is inserted into the data. For example, if a byte exceeds a value of 128 (out of 256), then the process will insert a random byte of data and then continue with the encryption process described above. Optionally, a second noise threshold, another trigger or an initial setting can be used to control the number of random bytes inserted into the data. That is, when a byte exceeds the noise threshold, any number of bytes of noise can be inserted into the data stream. Using noise helps to further blind the encrypted data.

Once encrypted, the encrypted data may be stored in memory for subsequent use and/or transmitted to another party. Upon receipt, the receiving party can decrypt the encrypted data using the inverse EXCITE process described above.

A more detailed description of the EXCITE technique follows below.

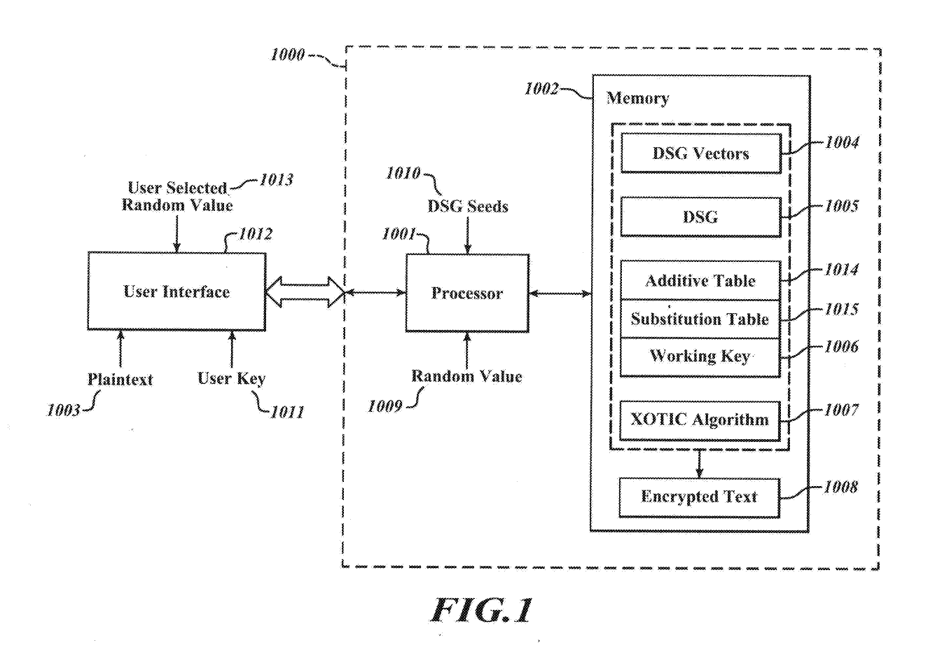

Referring now to the drawings, wherein like reference numerals denote like or corresponding parts throughout the drawings and, more particularly to FIG. 1, there is shown a general system configured for use in performing the disclosed rapid and highly secure cryptographic technique, (EXCITE). The system 1000 includes a processor 1001 for operating on the data (e.g. encrypting user supplied plaintext 1003 using an EXCITE algorithm 1007), and a memory 1002. In one or more of the embodiments of the present disclosure, the memory 1002 can store DSG vectors 1004, a DSG 1005, an internal working key 1006, an additive table 1014, a substitution table 1015, the EXCITE algorithm 1007, and the generated encrypted text 1008 itself. Moreover, it will be appreciated that, any processor or memory configuration can be used without departing from the disclosed technique. For example, a remote processor and/or memory can be used.

More particularly, the processor 1001 accesses a random value 1009 and one or more DSG seeds 1010. These values (1009 and 1010) are delivered from any random sources (e.g., noise detected by Search for Extra Terrestrial Intelligence (SETI), or the like). In one embodiment, the processor 1001 receives the DSG seeds 1010 via a user interface 1012. The processor 1001 also receives a user key 1011 and the plaintext data 1003 via the user interface 1012. Optionally, the processor receives a second user selected random value 1013, via the user interface 1012. It is appreciated, however, that input of variables can be made through any appropriate mechanism or method.

The user interface 1012 can be any appropriate device to enable the user to supply a desired form of data. By way of example only, the user interface 1012 can be a display used in association with a touch screen device, mouse, keyboard or any other suitable input device for enabling the user to supply the user key 1011, plaintext data 1003 and optionally, the user selected random value 1013 and the one or more DSG seeds 1010.

In operation, the processor 1001 receives the user key 1011 and the plaintext data 1003 via the user interface 1012. In addition, the processor accesses the one or more random values 1009 and the one or more DSG seeds 1010 from the one or more random sources and, optionally, from the user. The processor places each of the received data (e.g., the user key 1011 and the plaintext data 1003) and the accessed data (random values 1009 and the DSG seeds 1010) into the memory 1002. The processor 1001 then mathematically processes the random value(s) 1009 and the DSG seeds 1010 to generate an initialization value (IV) 1016. Optionally, the processor may merge the random value(s) 1009 with a user selected random value 1013 before mathematically processing the resultant random value and the DSG seeds 1010 to generate the initialization value (IV) 1016. Of course, in one or more embodiments, a plurality of initialization values (IV) 1016 may be used.

By way of example only, and not by way of limitation, the DSG seeds 1010 can be of any length and of any quantity. For clarity, the DSG seeds 1010 are additional random values. In some embodiments, while any random value may be used as the DSG seeds 1010, it is desired that the DSG seeds 1010 are mathematically congruent to the formulas and algorithms used in the DSG 1005. For example, a value of 0 to −1, or all seeds being the same, may not be used as DSG seeds 1010 as those values would reduce the randomness of the initialization value (IV) 1016. The greater the mathematical dissimilarity of the DSG seeds 1010 the better.

Once the initialization value (IV) 1016 is created by the processor 1001, the processor 1001 mathematically processes the initialization value (IV) 1016 along with the user key 1011 to create initial DSG vectors 1004. The initial DSG vectors 1004 are inputted into the DSG 1005. Using the DSG 1005 and the DSG vectors 1004, the processor 1001 then creates an additive table 1014, a substitution table 1015, and an initial internal working key 1006 (the working key 1006 being generated from the user key). Generally, all the data processing is done by the processor 1001 at a byte level.

Once the additive table 1014 and the substitution table 1015 are created, they remain static during the entire encryption process. In some embodiments, the substitution table 1015, which is created by the processor 1001 using the DSG 1005 and the DSG vectors 1004, is 256 bytes with values of 0-255 randomly spread throughout the table, but having no repetition of values. Similarly, the additive table 1014 that is created by the processor 1001, using the DSG 1005 and the DSG vectors 1004, is 256 bytes containing random values of 0-255. However, unlike the substitution table 1015, the additive table 1014 may include repeated values.

Generally, and in some embodiments, the initial internal working key 1006 is twice the length of the user key 1011. However, an initial internal working key 1006 of any length may be used. During encryption, an n byte long initial internal working key 1006 can be used to process n bytes of plaintext data 1003. If the initial internal working key 1006 is exhausted during the encryption of the plaintext data 1003, the processor 1001 generates a new n byte long internal working key using the DSG 1005 and the DSG vectors 1004 to process the next n bytes of plaintext data 1003 into encrypted data. The process of generating new internal working keys 1006 continues until all the plaintext data 1003 has been encrypted.

In some embodiments, when creating each of the additive table 1014 and the substitution table 1015 the DSG 1005 is shuffled 256 times, i.e., the DSG will place 256 random characters in each of the additive table 1014 and the substitution table 1015. As each random value is placed into the additive table 1014 and the substitution table 1015, the DSG vectors are mathematically changed and then used by the DSG 1005 to create the next random value. This process continues during the creation of the internal working key 1006, as well.

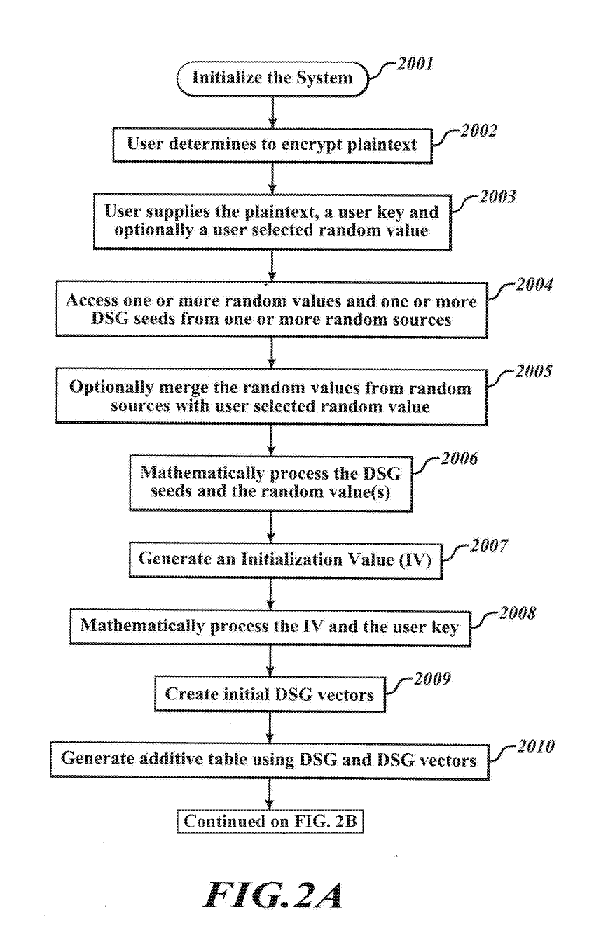

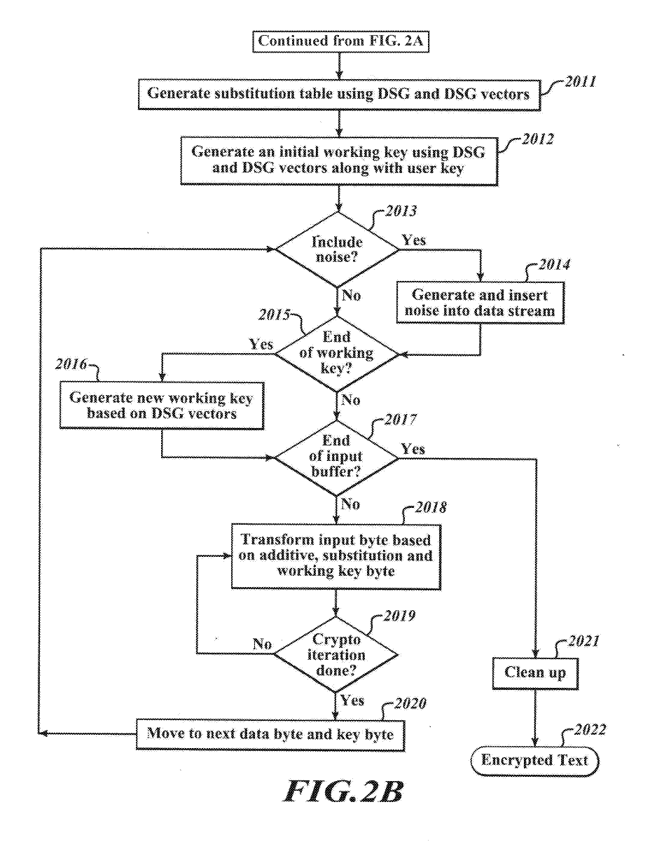

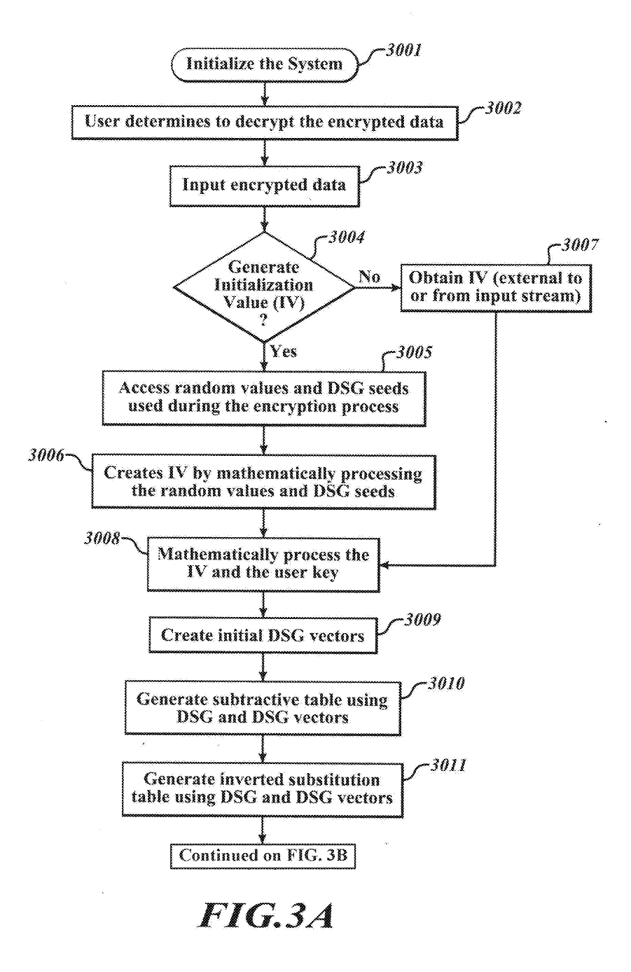

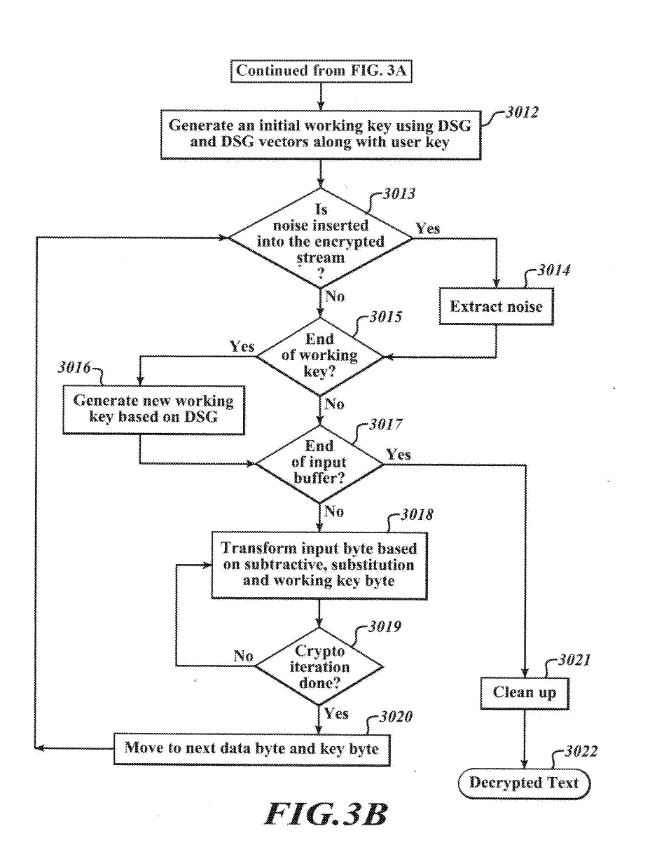

Once the initial internal working key 1006, the additive table 1014 and the substitution table 1015 are created by the DSG 1005, the processor 1001 stores the initial internal working key 1006, the additive table 1014 and the substitution table 1015 in memory 1002. The processor 1001 operates on the plaintext data 1003 using the EXCITE algorithm 1007, the working key 1006, the additive table 1014 and the substitution table 1015 to encrypt the plaintext 1003 data (i.e., performing multiple addition, XOR and substitution operations on the plaintext data 1003). More particularly, the system 1000 uses the processes described below with regard to FIGS. 2 and 3 to perform the EXCITE technique to encrypt the plaintext data 1003. The encrypted text 1008 created from the user supplied plaintext data 1003 is then stored in the memory 1002 for subsequent access.

One of ordinary skill in the art will appreciate that not all systems have all these components and that such systems may have other components in addition to, or in lieu of, those components mentioned here. Furthermore, while these components are viewed and described separately, various components may be integrated into a single unit in some embodiments.

Further, representative examples utilizing many of these features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm as used herein is generally conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms presented herein are not inherently related to any particular computer or other apparatus. Various general-purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

In the following description, certain specific details are set forth in order to provide a thorough understanding of various disclosed embodiments. However, one skilled in the relevant art will recognize that embodiments may be practiced without one or more of these specific details, or with other methods, components, materials, and the like. In other instances, well-known structures associated with servers, networks, displays, media handling, computers and/or processor/control systems have not been shown or described in detail to avoid unnecessarily obscuring descriptions of the embodiments.

Unless otherwise indicated, the functions described herein may be performed by executable code and instructions stored in a computer readable medium and running on one or more processor-based systems. However, state machines and/or hardwired electronic circuits may also be utilized. Further, with respect to the example processes described herein, not all of the process states need to be reached, nor do the states have to be performed in the illustrated order. Further, certain process states that are illustrated as being serially performed may be performed in parallel.

Similarly, unless expressly stated to be otherwise, while certain embodiments may refer to a Personal Computer (“PC”) system or data device, other computer or electronic systems may be used as well, such as, without limitation, an interactive television, a network-enabled personal digital assistant (“PDA”), a network game console, a networked entertainment device, a smart phone (e.g., with an operating system and on which a user may install applications) and the like.

In addition, while certain user inputs are described as being provided via phone key-presses, data entry via a keyboard, or by clicking a computer mouse or button, touchscreen optionally, user inputs may be provided using other techniques, such as by voice or otherwise. The example screen layouts, appearance, and terminology as depicted and described herein, are intended to be illustrative and exemplary, and in no way limit the scope of the invention as claimed.

The terms, “for example,” “e.g.,” “in one/another aspect,” “in one/another scenario,” “in one/another version,” “in some configurations” “in some implementations,” “preferably,” “usually,” “typically,” “may,” and “optionally,” as used herein, are intended to be used to introduce non-limiting embodiments. Unless expressly stated otherwise, while certain references are made to certain example system components or services, other components and services may be used as well and/or the example components may be combined into fewer components and/or divided into further components. The terms, “member” and “user,” are used interchangeably. Members and users are subscribed to or enrolled in a network service or network of users.

Referring again to the drawings, and more particularly to FIGS. 2A and 2B, there is shown one embodiment of the encryption process using the EXCITE technique.

Beginning at step 2001, the processor 1001 initializes the system 1000 to perform the disclosed encryption process. At step 2002, the user determines to encrypt plaintext data 1003. Next, at step 2003 the user supplies the plaintext data 1003 to be encrypted, a user key 1011 and, optionally, a user selected random value 1013 via the user interface 1012. Of course, all this information, e.g., the user key 1011, the plaintext data 1003 and the user selected random value 1013 may be supplied by any other appropriate source or mechanism.

At step 2004, the processor 1001 accesses one or more random values (RV) 1009 and one or more DSG seeds 1010 from one or more random sources, e.g., noise detected by Search for Extra Terrestrial Intelligence (SETI) or the like. In one embodiment, the processor 1001 can receive the DSG seeds 1010 via the user interface 1012. However, the DSG seeds 1010 and the random values 1009 can be supplied by any appropriate source or mechanism. Optionally, at step 2005, the processor 1001 may merge the random values 1009 with the user selected random value 1013, if any. Next, at step 2006, the processor 1001 mathematically processes the DSG seeds 1010 and the random values 1009 (or optionally, random values 1009 and 1013).

Next, at step 2007, the processor 1001 mathematically processes the DSG seeds 1010 and the random values 1009 to generate an initialization value (IV) 1016. Then, at step 2008, the processor mathematically processes the initialization value (IV) 1016 and the user key 1011. At step 2009, this processing results in initial DSG vectors 1004.

The initial DSG vectors are input into the DSG algorithm. At steps 2010 and 2011, the processor 1001 generates an additive table 1014 and a substitution table 1015 using the DSG 1005 and the DSG vectors 1004. The order of the creation of the additive table 1014 and the substitution table 1015 can be altered, i.e., the substitution table 1015 can be created before the additive table 1014 and vice-versa. However, the table creation order must remain consistent during both the encryption and decryption process. Next, at step 2012, the processor 1001 generates an initial internal working key 1006 from the user key 1011 using the DSG 1005 and the DSG vectors 1004.

Next, at step 2013, the process queries whether noise should be added to the data stream. In this regard, the processor 1001 creates a threshold for noise generation for use in the encryption process and the processor 1001 then determines if the current byte in the plaintext data 1003 exceeds the determined noise threshold. If the processor 1001 determines that the byte of plaintext data 1003 exceeds the noise threshold, the process continues to step 2014. At step 2014, the processor 1001 will generate the noise and insert the generated noise (i.e., random bytes) into the data stream. Optionally, a second noise threshold, another trigger or an initial setting can be used to control the number of random bytes inserted into the data stream. That is, when a byte exceeds the noise threshold, any number of bytes of noise can be inserted into the data stream. Using noise helps to further blind the encrypted data 1008.

If the processor 1001 at step 2013 determines that no noise is to be generated, the process continues at step 2015. At step 2015, the processor 1001 determines if the current working key 1006 has been exhausted, i.e., it has run its length of n bytes. If the working key 1006 is not yet exhausted, the process continues to step 2017 to determine if additional plaintext data 1003 needs to be encrypted. However, if at step 2015 the processor 1001 determines that the working key 1006 is exhausted, the process will continue to step 2016. At step 2016, the DSG 1005 will use the current DSG vectors 1004 to create a new working key 1006 of n bytes and then the process will continue to step 2017.

At step 2017, the processor 1001 determines whether there is still plaintext data 1003 remaining to be encrypted. If step 2017 determines that all the plaintext data 1003 has been encrypted, the process continues to step 2021 for clean up operations and then to step 2022 where the encrypted text 1008 is output for storage and/or subsequent transmission to another party or other use. On the other hand, if additional plaintext data 1003 does remain to be encrypted, the process continues to step 2018.

At step 2018, the next byte of plaintext data 1008 is transformed. The processor 1001 encrypts the plaintext data 1003 using the additive table 1014, the substitution table 1015 and the internal working key 1006 to perform the appropriate addition, XOR and substitution operations on the current byte of plaintext data 1003. Once step 2018 is completed, the process continues to step 2019 to verify that the current iteration has been completed. If not, the process returns to step 2018 to complete the encryption process. However, if the iteration is complete, the process continues to step 2020 to access the next byte of plaintext data 1003 and the next byte of the working key 1006 used in the encryption process. Step 2020 will return to step 2013 in the encryption process to process the next byte of plaintext data 1003.

Stated differently, and by way of example only, if an addition/XOR/substitution processing order is applied to the plaintext data 1003, then the following steps summarize the encryption process:

1. A byte of plaintext data 1003 is processed by adding the byte from the additive table 1014 modulus the input position, thus blinding the original plaintext data 1003 byte.

2. The XOR operation is then performed on this modified byte (from step 1) using the next byte of the working key 1006 to blind the above modified byte.

3. Next, the correct substitution byte for this modified byte (from step 2) is determined.

4. Optionally, steps 1-3 can be repeated any number of times so that the modified byte is used as the input byte for these steps. By doing this repeatedly, the original data is blinded ‘n’ times.

5. Next this substitution byte is stored in the output stream to further blind the above modified byte (from step 3).

6. Optionally, the process determines if noise should be injected into the data stream.

7. The above steps are repeated until the entire length of the working key 1006 has been used.

If the working key 1006 is exhausted, the process generates a new working key 1006 for use with encrypting the next n bytes of plaintext data 1003.

The above process repeats until all the plaintext data 1003 has been encrypted.

By way of example only, and not by way of limitation, the following is an implementation of the disclosed encryption process using the EXCITE technique.

### Example 1

In one embodiment, plaintext data 1003 is encrypted using the encryption process as disclosed in FIG. 2. In this case, only one additive/XOR/substitution iteration pass is made per byte of plaintext data 1003. The hexadecimal format is used for display purposes only. Any number format (e.g. binary and the like) can be used to implement the disclosed encryption process.

i. Plaintext data 1003 is supplied by the user via the user interface 1012 or other appropriate mechanism: In this example, the plaintext data 1003 is “Xotic Process”.
The plaintext “Xotic Process” in shown in hexadecimal format as: 58 6f 74 69 63 20 50 72 6f 63 65 73 73.
The plaintext “Xotic Process” supplied by the user is stored in the memory 1002.

ii. User key 1011 is supplied by the user via user interface 1012 or by other appropriate mechanism: In this example, the user key is “xotic”.
“xotic” as in hexadecimal format: 78 6f 74 69 63
The user key “xotic” is stored in the memory 1002.

iii. The DSG seeds 1010 accessed by the processor 1001 or supplied by the user via the user interface 1012 or via other appropriate mechanism are:
DSG seed 1=1819145164
DSG seed 2=2133878803
DSG seed 3=578068005
DSG seed 4=1313382323
DSG seed 5=1542521175
DSG seed 6=1358903071
DSG seed 7=1373624615
DSG seed 8=634434395

iv. A random value 1009 accessed by the processor 1001 from any random source is 162875739.

v. An initialization value (IV) 1016 is generated by mathematically processing the DSG seeds 1010 and the random value 1009. There is no optional user selected random value 1013 used in this example.

vi. The initial DSG vectors 1004 are then generated from mathematically processing the initialization value (IV) 1016 and the user key 1011. The initial DSG vectors 1004 are, therefore:
DSG vector 1=2113407355
DSG vector 2=1737839646
DSG vector 3=1018411089
DSG vector 4=1447247159
DSG vector 5=1867667233
DSG vector 6=1973043051
DSG vector 7=1913358075
DSG vector 8=1149134690

vii. Additive table 1014 is generated by the processor 1001 using the DSG 1005 and the DSG vectors 1004:

| | 00 | 01 | 02 | 03 | 04 | 05 | 06 | 07 | 08 | 09 | 0a | 0b | 0c | 0d | 0e | 0f |
|---|---|---|---|---|---|---|---|---|---|---|---|---|---|---|---|---|
| 00 | e0 | 74 | 6f | 9a | 0e | 47 | c9 | bd | 11 | d5 | ca | 11 | f3 | d1 | 07 | 6f |
| 10 | 40 | 3c | 04 | 88 | 3b | 4c | 97 | 03 | 1a | 12 | 0f | dd | 8c | c7 | a6 | 2e |
| 20 | a8 | 67 | 55 | e6 | 14 | 5d | a0 | 18 | 43 | cc | 5f | 13 | dc | 61 | fa | 05 |
| 30 | 61 | 94 | be | 7f | 91 | 1e | b1 | 93 | db | 6c | 80 | fa | 37 | eb | 31 | 49 |
| 40 | 2f | 9c | 68 | 8c | 7c | 20 | 5b | e1 | 9b | eb | 45 | 6e | ec | 84 | 26 | b8 |
| 50 | 17 | 09 | 7b | f6 | 08 | 27 | 9b | 89 | b4 | c0 | 0a | a7 | db | a5 | df | 57 |
| 60 | 9b | 15 | e3 | 3f | f8 | 6e | 88 | 41 | 39 | db | e3 | a5 | d7 | 43 | a6 | 57 |
| 70 | 46 | c6 | e3 | 2e | 6f | 39 | 41 | 08 | 01 | dd | d7 | ba | 15 | b2 | 06 | f5 |
| 80 | 0b | ed | d2 | d7 | 9f | e5 | bf | a7 | 80 | 3a | bc | 2b | 42 | f4 | b0 | 70 |
| 90 | 19 | b2 | 61 | 15 | c0 | b0 | e6 | 61 | d2 | db | 3d | 1a | 96 | cc | 2b | 86 |
| a0 | d5 | ed | 99 | e9 | 70 | ce | b6 | 5f | 06 | 3b | ad | 34 | 7c | 16 | c4 | 0b |
| b0 | 2c | 66 | a0 | 62 | 50 | ef | 34 | 5a | 06 | 70 | 04 | c2 | a8 | a4 | 10 | b2 |
| c0 | 0f | 36 | 54 | 53 | 5a | c6 | 00 | 4a | fb | 02 | 0e | 85 | 03 | b2 | e3 | bc |
| d0 | 16 | 31 | ed | 30 | 2b | c8 | 35 | e5 | b9 | 3f | e3 | fe | ca | f2 | b5 | 60 |
| e0 | 2a | fa | 25 | 46 | c0 | 71 | b0 | 64 | 65 | 56 | 65 | 4e | e1 | ad | 56 | 52 |
| f0 | 8b | 46 | ac | 76 | b5 | df | 86 | 45 | 00 | 6e | 99 | 1b | e1 | 00 | 7e | 08 |

viii. Substitution table 1015 is generated by the processor 1001 using the DSG 1005 and the DSG vectors 1004:

| | 00 | 01 | 02 | 03 | 04 | 05 | 06 | 07 | 08 | 09 | 0a | 0b | 0c | 0d | 0e | 0f |
|---|---|---|---|---|---|---|---|---|---|---|---|---|---|---|---|---|
| 00 | f6 | f2 | 2a | fc | d7 | 9f | e8 | 31 | 64 | eb | 1a | 44 | a9 | 1d | ef | 1e |
| 10 | 06 | 2b | 7b | 91 | ac | ab | e7 | dc | c3 | c2 | 82 | 29 | f1 | 90 | a0 | 56 |
| 20 | 16 | 80 | af | 97 | ad | ee | 23 | a6 | 6b | 9c | 01 | b8 | 89 | bb | a2 | 5d |
| 30 | dd | 87 | 46 | 4d | 08 | 95 | b3 | 22 | 85 | 4c | 39 | 6f | 8f | 60 | 32 | 5f |
| 40 | 54 | 48 | 0e | e1 | 61 | f8 | 6e | 28 | e9 | b4 | 2f | c8 | ba | a4 | 2c | 75 |
| 50 | 04 | 6c | 2e | 7f | 86 | 14 | fd | 4e | f5 | fe | 3a | 74 | a7 | 3f | bc | 98 |
| 60 | c1 | be | 6a | e3 | b6 | d9 | da | 5a | c0 | df | 96 | cd | 9e | 93 | 49 | 27 |
| 70 | cf | fb | c5 | 77 | 7e | 3c | 59 | a8 | b0 | 83 | 34 | a1 | 5c | e0 | 42 | 07 |
| 80 | cc | d5 | cb | fa | 35 | a3 | ed | ae | 50 | 11 | 53 | 4b | 71 | d3 | 3e | c9 |
| 90 | 1b | 37 | 02 | 9d | 6d | d0 | 21 | 65 | 38 | 70 | 4a | ff | 68 | 45 | 00 | 79 |
| a0 | 51 | e2 | 73 | b7 | d6 | 8c | 7a | a5 | 43 | de | b2 | d4 | 20 | 15 | 33 | d8 |
| b0 | 5e | 10 | 69 | 84 | 09 | 05 | 1f | ce | 0c | f9 | 40 | 19 | 62 | d2 | 55 | 26 |
| c0 | b1 | 99 | 81 | 13 | 52 | e4 | 24 | 9b | 18 | 0d | 66 | b9 | 57 | e6 | 47 | 94 |
| d0 | b5 | d1 | 0f | 17 | 88 | c4 | 76 | e5 | 2d | 1c | 58 | c6 | f3 | bd | 0b | ca |
| e0 | db | 0a | 12 | 78 | bf | 25 | 3b | 8d | ec | 36 | 9a | 8e | 30 | 5b | 7c | 72 |
| f0 | 8b | ea | f4 | 8a | f0 | 67 | 3d | f7 | 4f | 7d | 41 | aa | 92 | 63 | 03 | c7 |

ix. Initial internal working key 1006 is generated by the processor 1001 using the DSG 1005 and the DSG vectors 1004 in combination with the user key 1011:
41 42 09 0e 75 4a 52 05 97 62

x. What follows is the step by step encryption process of the first byte of the plaintext “Xotic Process” using an Addition/XOR/Substitution processing order.
1) Original value (byte) at the plaintext data position 0=‘X’ or 58 (hexadecimal)
2) To that value add value e0 from position 00 of the additive table 1014 to get new value 38
3) To that value XOR the initial working key 1006 to provide the value 41 at position 00 to get new value 79
4) Substitute value from position 79 of the substitution table 1015 to get the final value 83.
5) Repeat the above steps until the initial working key 1006 is exhausted and then generate a new working key when the current working key is exhausted.
6) The above 5 steps are repeated for each byte of the plaintext data 1003 data until the data is exhausted.

Stated differently, at step 1 of the encryption process described above, the byte to be processed is the data byte, which is an ‘X’ or hexadecimal value 58. Next, at step 2, the hexadecimal value 58 is added to e0 from position 00 of the additive table 1014, which results in 38. The actual numeric value from the addition is hexadecimal 138 which is too large to fit in the 8 bits of a byte and, therefore, such value is wrapped to 38. At step 3, the value 38 from step 2 is XOR'd with the initial working key 1006 value 41 from position 00, which results in a value of 79. A person skilled in the art will appreciate that the order of the addition, XOR and substitution operations can be altered at any time during the current encryption. For example, add/XOR/substitute becoming XOR/add/substitute, or the like.

Next, at step 4, the position 79 in the substitution table 1015 returns a value of 83, which is the final value of the data byte “X” after encryption. The above steps are repeated until the initial working key 1006 is exhausted. Once the initial working key 1006 is exhausted, at step 5, a new working key is generated. The above 5 steps are repeated for each byte of the plaintext data 1003 until the plaintext data 1003 is encrypted.

In another example, the EXCITE encryption process is shown with the use of multiple iterations. While three iterations are shown in the example below, any number of iterations may be used.

### Example 2

Iteration count=3
The same initial data is used as described above but with additional encryption iterations.
Original data

### Xotic Process

58 6f 74 69 63 20 50 72 6f 63 65 73 73

### Original key

xotic
78 6f 74 69 63
****************************************
Encryption process
****************************************
Initializing for encryption
DSG seeds for demo are
DSG seed 1=1819145164
DSG seed 2=2133878803
DSG seed 3=578068005
DSG seed 4=1313382323
DSG seed 5=1542521175
DSG seed 6=1358903071
DSG seed 7=1373624615
DSG seed 8=634434395
Initializing DSG with a random value of 162875739
DSG vectors for demo are
DSG vector 1=2113407355
DSG vector 2=1737839646
DSG vector 3=1018411089
DSG vector 4=1447247159
DSG vector 5=1867667233
DSG vector 6=1973043051
DSG vector 7=1913358075
DSG vector 8=1149134690
DSG initialized and ready for use
Building Working key from supplied key
key=41 42 09 0e 75 4a 52 05 97 62

Encryption substitution table

| | 00 | 01 | 02 | 03 | 04 | 05 | 06 | 07 | 08 | 09 | 0a | 0b | 0c | 0d | 0e | 0f |
|---|---|---|---|---|---|---|---|---|---|---|---|---|---|---|---|---|
| 00 | f6 | f2 | 2a | fc | d7 | 9f | e8 | 31 | 64 | eb | 1a | 44 | a9 | 1d | ef | 1e |
| 10 | 06 | 2b | 7b | 91 | ac | ab | e7 | dc | c3 | c2 | 82 | 29 | f1 | 90 | a0 | 56 |
| 20 | 16 | 80 | af | 97 | ad | ee | 23 | a6 | 6b | 9c | 01 | b8 | 89 | bb | a2 | 5d |
| 30 | dd | 87 | 46 | 4d | 08 | 95 | b3 | 22 | 85 | 4c | 39 | 6f | 8f | 60 | 32 | 5f |
| 40 | 54 | 48 | 0e | e1 | 61 | f8 | 6e | 28 | e9 | b4 | 2f | c8 | ba | a4 | 2c | 75 |
| 50 | 04 | 6c | 2e | 7f | 86 | 14 | fd | 4e | f5 | fe | 3a | 74 | a7 | 3f | bc | 98 |
| 60 | c1 | be | 6a | e3 | b6 | d9 | da | 5a | c0 | df | 96 | cd | 9e | 93 | 49 | 27 |
| 70 | cf | fb | c5 | 77 | 7e | 3c | 59 | a8 | b0 | 83 | 34 | a1 | 5c | e0 | 42 | 07 |
| 80 | cc | d5 | cb | fa | 35 | a3 | ed | ae | 50 | 11 | 53 | 4b | 71 | d3 | 3e | c9 |
| 90 | 1b | 37 | 02 | 9d | 6d | d0 | 21 | 65 | 38 | 70 | 4a | ff | 68 | 45 | 00 | 79 |
| a0 | 51 | e2 | 73 | b7 | d6 | 8c | 7a | a5 | 43 | de | b2 | d4 | 20 | 15 | 33 | d8 |
| b0 | 5e | 10 | 69 | 84 | 09 | 05 | 1f | ce | 0c | f9 | 40 | 19 | 62 | d2 | 55 | 26 |
| c0 | b1 | 99 | 81 | 13 | 52 | e4 | 24 | 9b | 18 | 0d | 66 | b9 | 57 | e6 | 47 | 94 |
| d0 | b5 | d1 | 0f | 17 | 88 | c4 | 76 | e5 | 2d | 1c | 58 | c6 | f3 | bd | 0b | ca |
| e0 | db | 0a | 12 | 78 | bf | 25 | 3b | 8d | ec | 36 | 9a | 8e | 30 | 5b | 7c | 72 |
| f0 | 8b | ea | f4 | 8a | f0 | 67 | 3d | f7 | 4f | 7d | 41 | aa | 92 | 63 | 03 | c7 |

Encryption additive table

| | 00 | 01 | 02 | 03 | 04 | 05 | 06 | 07 | 08 | 09 | 0a | 0b | 0c | 0d | 0e | 0f |
|---|---|---|---|---|---|---|---|---|---|---|---|---|---|---|---|---|
| 00 | e0 | 74 | 6f | 9a | 0e | 47 | c9 | bd | 11 | d5 | ca | 11 | f3 | d1 | 07 | 6f |
| 10 | 40 | 3c | 04 | 88 | 3b | 4c | 97 | 03 | 1a | 12 | 0f | dd | 8c | c7 | a6 | 2e |
| 20 | a8 | 67 | 55 | e6 | 14 | 5d | a0 | 18 | 43 | cc | 5f | 13 | dc | 61 | fa | 05 |
| 30 | 61 | 94 | be | 7f | 91 | 1e | b1 | 93 | db | 6c | 80 | fa | 37 | eb | 31 | 49 |
| 40 | 2f | 9c | 68 | 8c | 7c | 20 | 5b | e1 | 9b | eb | 45 | 6e | ec | 84 | 26 | b8 |
| 50 | 17 | 09 | 7b | f6 | 08 | 27 | 9b | 89 | b4 | c0 | 0a | a7 | db | a5 | df | 57 |
| 60 | 9b | 15 | e3 | 3f | f8 | 6e | 88 | 41 | 39 | db | e3 | a5 | d7 | 43 | a6 | 57 |
| 70 | 46 | c6 | e3 | 2e | 6f | 39 | 41 | 08 | 01 | dd | d7 | ba | 15 | b2 | 06 | f5 |
| 80 | 0b | ed | d2 | d7 | 9f | e5 | bf | a7 | 80 | 3a | bc | 2b | 42 | f4 | b0 | 70 |
| 90 | 19 | b2 | 61 | 15 | c0 | b0 | e6 | 61 | d2 | db | 3d | 1a | 96 | cc | 2b | 86 |
| a0 | d5 | ed | 99 | e9 | 70 | ce | b6 | 5f | 06 | 3b | ad | 34 | 7c | 16 | c4 | 0b |
| b0 | 2c | 66 | a0 | 62 | 50 | ef | 34 | 5a | 06 | 70 | 04 | c2 | a8 | a4 | 10 | b2 |
| c0 | 0f | 36 | 54 | 53 | 5a | c6 | 00 | 4a | fb | 02 | 0e | 85 | 03 | b2 | e3 | bc |
| d0 | 16 | 31 | ed | 30 | 2b | c8 | 35 | e5 | b9 | 3f | e3 | fe | ca | f2 | b5 | 60 |
| e0 | 2a | fa | 25 | 46 | c0 | 71 | b0 | 64 | 65 | 56 | 65 | 4e | e1 | ad | 56 | 52 |
| f0 | 8b | 46 | ac | 76 | b5 | df | 86 | 45 | 00 | 6e | 99 | 1b | e1 | 00 | 7e | 08 |

--------------------
Original data
58 6f 74 69 63 20 50 72 6f 63 65 73 73
--------------------
--------------------

### Encrypting

--------------------
Original byte->add from table->xor with key->swap with subst=encrypted byte
Pass: 01 Original value (byte) at data position 0=‘X’ or 58->Add value e0 from additive position 00 to get new value 38->Xor key value 41 from position 00 to get new value 79->Substitute value from position 79 to get final value 83
Pass: 02 Modified from previous pass 83->Add value e0 from additive position 00 to get new value 63->Xor key value 41 from position 00 to get new value 22->Substitute value from position 22 to get final value af
Pass: 03 Modified from previous pass af->Add value e0 from additive position 00 to get new value 8f->Xor key value 41 from position 00 to get new value ce->Substitute value from position ce to get final value 47
Pass: 01 Original value (byte) at data position 1=‘o’ or 6f->Add value 74 from additive position 01 to get new value e3->Xor key value 42 from position 01 to get new value a1->Substitute value from position a1 to get final value e2
Pass: 02 Modified from previous pass e2->Add value 74 from additive position 01 to get new value 56->Xor key value 42 from position 01 to get new value 14->Substitute value from position 14 to get final value ac
Pass: 03 Modified from previous pass ac->Add value 74 from additive position 01 to get new value 20->Xor key value 42 from position 01 to get new value 62->Substitute value from position 62 to get final value 6a
Pass: 01 Original value (byte) at data position 2=‘t’ or 74->Add value 6f from additive position 02 to get new value e3->Xor key value 09 from position 02 to get new value ea->Substitute value from position ea to get final value 9a
Pass: 02 Modified from previous pass 9a->Add value 6f from additive position 02 to get new value 09->Xor key value 09 from position 02 to get new value 00->Substitute value from position 00 to get final value f6
Pass: 03 Modified from previous pass f6->Add value 6f from additive position 02 to get new value 65->Xor key value 09 from position 02 to get new value 6c->Substitute value from position 6c to get final value 9e
Pass: 01 Original value (byte) at data position 3=‘i’ or 69->Add value 9a from additive position 03 to get new value 03->Xor key value 0e from position 03 to get new value 0d->Substitute value from position 0d to get final value 1d
Pass: 02 Modified from previous pass 1d->Add value 9a from additive position 03 to get new value b7->Xor key value 0e from position 03 to get new value b9->Substitute value from position b9 to get final value f9
Pass: 03 Modified from previous pass f9->Add value 9a from additive position 03 to get new value 93->Xor key value 0e from position 03 to get new value 9d->Substitute value from position 9d to get final value 45
Pass: 01 Original value (byte) at data position 4=‘c’ or 63->Add value 0e from additive position 04 to get new value 71->Xor key value 75 from position 04 to get new value 04->Substitute value from position 04 to get final value d7
Pass: 02 Modified from previous pass d7->Add value 0e from additive position 04 to get new value e5->Xor key value 75 from position 04 to get new value 90->Substitute value from position 90 to get final value 1b
Pass: 03 Modified from previous pass 1b->Add value 0e from additive position 04 to get new value 29->Xor key value 75 from position 04 to get new value 5c->Substitute value from position 5c to get final value a7
Pass: 01 Original value (byte) at data position 5=″ or 20->Add value 47 from additive position 05 to get new value 67->Xor key value 4a from position 05 to get new value 2d->Substitute value from position 2d to get final value bb
Pass: 02 Modified from previous pass bb->Add value 47 from additive position 05 to get new value 02->Xor key value 4a from position 05 to get new value 48->Substitute value from position 48 to get final value e9
Pass: 03 Modified from previous pass e9->Add value 47 from additive position 05 to get new value 30->Xor key value 4a from position 05 to get new value 7a->Substitute value from position 7a to get final value 34
Pass: 01 Original value (byte) at data position 6=‘P’ or 50->Add value c9 from additive position 06 to get new value 19->Xor key value 52 from position 06 to get new value 4b->Substitute value from position 4b to get final value c8
Pass: 02 Modified from previous pass c8->Add value c9 from additive position 06 to get new value 91->Xor key value 52 from position 06 to get new value c3->Substitute value from position c3 to get final value 13
Pass: 03 Modified from previous pass 13->Add value c9 from additive position 06 to get new value dc->Xor key value 52 from position 06 to get new value 8e->Substitute value from position 8e to get final value 3e
Pass: 01 Original value (byte) at data position 7=‘r’ or 72->Add value bd from additive position 07 to get new value 2f->Xor key value 05 from position 07 to get new value 2a->Substitute value from position 2a to get final value 01
Pass: 02 Modified from previous pass 01->Add value bd from additive position 07 to get new value be->Xor key value 05 from position 07 to get new value bb->Substitute value from position bb to get final value 19
Pass: 03 Modified from previous pass 19->Add value bd from additive position 07 to get new value d6->Xor key value 05 from position 07 to get new value d3->Substitute value from position d3 to get final value 17
Pass: 01 Original value (byte) at data position 8=‘o’ or 6f->Add value 11 from additive position 08 to get new value 80->Xor key value 97 from position 08 to get new value 17->Substitute value from position 17 to get final value dc
Pass: 02 Modified from previous pass dc->Add value 11 from additive position 08 to get new value ed->Xor key value 97 from position 08 to get new value 7a->Substitute value from position 7a to get final value 34
Pass: 03 Modified from previous pass 34->Add value 11 from additive position 08 to get new value 45->Xor key value 97 from position 08 to get new value d2->Substitute value from position d2 to get final value 0f
Pass: 01 Original value (byte) at data position 9=‘c’ or 63->Add value d5 from additive position 09 to get new value 38->Xor key value 62 from position 09 to get new value 5a->Substitute value from position 5a to get final value 3a
Pass: 02 Modified from previous pass 3a->Add value d5 from additive position 09 to get new value 0f->Xor key value 62 from position 09 to get new value 6d->Substitute value from position 6d to get final value 93
Pass: 03 Modified from previous pass 93->Add value d5 from additive position 09 to get new value 68->Xor key value 62 from position 09 to get new value 0a->Substitute value from position 0a to get final value 1a
Key exhausted.

### Generating new key

New key generated
key=62 3b 25 f0 a8 ac 4b 43 97 be
Pass: 01 Original value (byte) at data position 10=‘e’ or 65->Add value ca from additive position 0a to get new value 2f->Xor key value 62 from position 00 to get new value 4d->Substitute value from position 4d to get final value a4
Pass: 02 Modified from previous pass a4->Add value ca from additive position 0a to get new value 6e->Xor key value 62 from position 00 to get new value 0c->Substitute value from position 0c to get final value a9
Pass: 03 Modified from previous pass a9->Add value ca from additive position 0a to get new value 73->Xor key value 62 from position 00 to get new value 11->Substitute value from position 11 to get final value 2b
Pass: 01 Original value (byte) at data position 11=‘s’ or 73->Add value 11 from additive position 0b to get new value 84->Xor key value 3b from position 01 to get new value bf->Substitute value from position bf to get final value 26
Pass: 02 Modified from previous pass 26->Add value 11 from additive position 0b to get new value 37->Xor key value 3b from position 01 to get new value 0c->Substitute value from position 0c to get final value a9
Pass: 03 Modified from previous pass a9->Add value 11 from additive position 0b to get new value ba->Xor key value 3b from position 01 to get new value 81->Substitute value from position 81 to get final value d5
Pass: 01 Original value (byte) at data position 12=‘s’ or 73->Add value f3 from additive position 0c to get new value 66->Xor key value 25 from position 02 to get new value 43->Substitute value from position 43 to get final value e1
Pass: 02 Modified from previous pass e1->Add value f3 from additive position 0c to get new value d4->Xor key value 25 from position 02 to get new value f1->Substitute value from position f1 to get final value ea
Pass: 03 Modified from previous pass ea->Add value f3 from additive position 0c to get new value dd->Xor key value 25 from position 02 to get new value f8->Substitute value from position f8 to get final value 4f
--------------------
Encrypted data
47 6a 9e 45 a7 34 3e 17 0f 1a 2b d5 4f

Referring again to the drawings, and more particularly to FIGS. 3A and 3B, there is shown one embodiment of a decryption process.

Beginning at step 3001, the processor 1001 initializes the system 1000 to perform the disclosed decryption process. At step 3002, the user determines to decrypt the encrypted text 1008. At step 3003 the encrypted text 1008 is inputted into the system for decryption.

At step 3004, the processor 1001 determines if there is a need to generate an initialization value (IV) 1016 (e.g. the initialization value (IV) 1016 is not embedded in the encryption stream). If so, at step 3005, the processor 1001 accesses the random values (RV) 1009 and the DSG seeds 1010 that were stored in the memory 1002 or any other appropriate device or location, during the encryption process. In short, these variables can be provided to the recipient via any other appropriate mechanism or method. At step 3006, the processor 1001 creates the initialization value (IV) 1016 by mathematically processing the acquired DSG seeds 1010 and the random values 1009. The process then continues to step 3008.

On the other hand, if at step 3004 the processor determines that the initialization value (IV) 1016 is embedded in the encryption stream 1008, the process proceeds to step 3007. At step 3007, the processor 1001 accesses the initialization value (IV) 1016 from the encryption stream 1008 and the process continues to step 3008.

At step 3008, the processor 1001 accesses the user key 1011 stored in the memory 1002 or other appropriate device or location, during the encryption process and then mathematically processes the initialization value (IV) 1016 and the user key 1011. At the next step 3009, the processor 1001 generates the initial DSG vectors 1004 by mathematically processing the initialization value (IV) 1016 and the user key 1011.

At step 3010, the processor 1001 generates a subtractive table 3020 using the DSG 1005 and the DSG vectors 1004. The processor 1001 subsequently generates an inverted substitution table 3021 at step 3011, using the DSG 1005 and the DSG vectors 1004. The order of the creation of the subtractive table 3020 and the inverted substitution table 3021 must be consistent with the order used during encryption. Next, at step 3012, the processor 1001 creates the same initial internal working key 1006 that was created during the encryption process, using the DSG 1005 and the DSG vectors 1004 in combination with the user key 1011.

At step 3013, the process determines if there is any noise inserted into the encrypted data stream 1008. If at step 3013 the process determines that no noise is inserted into the encrypted data stream 1008, the process continues to step 3015. On the other hand, if at step 3013 the process determines that noise is inserted into the encrypted data stream 1008, at step 3014 the processor 1001 extracts such noise (i.e., the processor 1001 simply ignores the noise byte(s) and continues to the next piece of real data), and the process continues to step 3015.

Next, the decryption process continues at step 3015 where, the processor 1001 determines if the current working key 1006 has been exhausted, i.e., it has run its length of n bytes. If the working key 1006 is not yet exhausted, the process continues to step 3017 to determine if there is additional encrypted data 1008 that still needs to be decrypted. However, if at step 3015 the processor 1001 determines that the working key 1006 is exhausted, the process will continue to step 3016. At step 3016, the DSG 1005 will use the current DSG vectors 1004 to create a new working key 1006 of n bytes and then the process will continue to step 3017.

At step 3017, the processor 1001 determines whether there is still encrypted data 1008 remaining to be decrypted. If step 3017 determines that all the encrypted data 1008 has been decrypted, the process continues to step 3021 for clean up operations and then to step 3022 where the decrypted text is output for storage and/or other use. On the other hand, if additional encrypted data 1008 remains to be decrypted, the process continues to step 3018.

At step 3018, the next byte of encrypted data 1008 is transformed. The processor 1001 decrypts the encrypted data 1008 using the subtractive table 3020, inverted substitution table 3021 and the internal working key 1006 to perform the appropriate subtraction, XOR and substitution operations on the current byte of encrypted data 1008. Once step 3018 is completed, the process continues to step 3019 to verify that the current iteration has been completed. If not, the process returns to step 3018 to complete the decryption process. However, if the iteration is complete, the process continues to step 3020 to access the next byte of encrypted data 1008 and the next byte of the working key 1006 used in the decryption process. Step 3020 will return to step 3013 in the decryption process to process the next byte of encrypted data 1008.

In summary, therefore, to perform decryption using the EXCITE technique, the following steps are taken:

To prepare for the decryption process:
1. The initial DSG values must be either recreated or obtained. If the user supplies the random value generated during the encryption process, then the process can recreate the DSG values as per the encryption pattern. If the user did not supply such random values then the decryption process must obtain the DSG values from an external source, or extract them from the data stream. These values are used to initialize the DSG.
2. Next the DSG generates the same working key that was used for encryption from the user's supplied key based on the DSG values applied to the user's key.
3. Then create a substitution table of 256 bytes with the values 0-255 randomly spread around the table. Since this is for decryption, the substitution table is inverted from that used during encryption.
4. Then, create an additive table of 256 bytes containing random values from 0-255.

The above steps initialize the DSG for performing an appropriate decryption process.

Thereafter, the following steps are performed to actually decrypt the data (using a substitution/XOR/subtraction processing order):
1. Get a byte of encrypted data and determine if this is noise data. If so, simply ignore and move to the next piece of real data.
2. Find the correct substitution byte for this byte of encrypted data.
3. Extract the correct substitution byte to unblind the data.
4. Optionally, steps 1-3 can be repeated an optional number of times so that the modified byte is used as the input byte for these steps. By doing this repeatedly, the original data is unblinded ‘n’ times.
5. XOR this byte with the next byte of the current working key thus unblinding the above byte (from step 3)
6. Subtract the value from the subtractive table modulus the input position, thus unblinding the data byte (from step 5) into the original data byte.
7. Store this final value in the output stream.
8. Repeat the above steps until the entire length of the working key has been used.
9. Generate a new random key, if necessary.
10. Repeat the above steps until the entire input stream has been decrypted.

By way of example only, and not by way of limitation, the following is an implementation of the disclosed decryption process.

### Example 3

In one embodiment, encrypted text 1008 is decrypted using the decryption process as disclosed in FIG. 3. In this case, only one subtractive/XOR/substitution iteration pass is made per byte of encrypted text data 1008. The hexadecimal format is used for display purposes only. Any number format (e.g., binary and the like) can be used to implement the disclosed encryption process.

i. Inputted encrypted text 1008 as shown in hexadecimal format: 83 e2 9a 1d d7 bb c8 01 dc 3a a4 26 e1.
The encrypted text 1008 is stored in memory.

ii. User key 1011 used during the encryption process is accessed by the processor 1001: “xotic”
“xotic” in hexadecimal format: 78 6f 74 69 63

iii. The DSG seeds 1010 used during the encryption process are accessed by the processor 1001 from memory:
DSG seed 1=1819145164
DSG seed 2=2133878803
DSG seed 3=578068005
DSG seed 4=1313382323
DSG seed 5=1542521175
DSG seed 6=1358903071
DSG seed 7=1373624615
DSG seed 8=634434395

iv. A random value 1009 used during the encryption process accessed by the processor 1001 from memory 1002: 162875739. Again, no user selected random value 1013 is used in this example.

v. An initialization value (IV) 1016 is generated by mathematically processing the DSG seeds 1010 and the random value 1009

vi. The initial DSG vectors 1004 are then generated from mathematically processing the initialization value (IV) 1016 and the user key 1011. The initial DSG vectors 1004 are, therefore:
DSG vector 1=2113407355
DSG vector 2=1737839646
DSG vector 3=1018411089
DSG vector 4=1447247159
DSG vector 5=1867667233
DSG vector 6=1973043051
DSG vector 7=1913358075
DSG vector 8=1149134690

vii. Subtractive table 3020 is generated by the processor 1001 using the DSG 1005 and the DSG vectors 1004:

| | 00 | 01 | 02 | 03 | 04 | 05 | 06 | 07 | 08 | 09 | 0a | 0b | 0c | 0d | 0e | 0f |
|---|---|---|---|---|---|---|---|---|---|---|---|---|---|---|---|---|
| 00 | e0 | 74 | 6f | 9a | 0e | 47 | c9 | bd | 11 | d5 | ca | 11 | f3 | d1 | 07 | 6f |
| 10 | 40 | 3c | 04 | 88 | 3b | 4c | 97 | 03 | 1a | 12 | 0f | dd | 8c | c7 | a6 | 2e |
| 20 | a8 | 67 | 55 | e6 | 14 | 5d | a0 | 18 | 43 | cc | 5f | 13 | dc | 61 | fa | 05 |
| 30 | 61 | 94 | be | 7f | 91 | 1e | b1 | 93 | db | 6c | 80 | fa | 37 | eb | 31 | 49 |
| 40 | 2f | 9c | 68 | 8c | 7c | 20 | 5b | e1 | 9b | eb | 45 | 6e | ec | 84 | 26 | b8 |
| 50 | 17 | 09 | 7b | f6 | 08 | 27 | 9b | 89 | b4 | c0 | 0a | a7 | db | a5 | df | 57 |
| 60 | 9b | 15 | e3 | 3f | f8 | 6e | 88 | 41 | 39 | db | e3 | a5 | d7 | 43 | a6 | 57 |
| 70 | 46 | c6 | e3 | 2e | 6f | 39 | 41 | 08 | 01 | dd | d7 | ba | 15 | b2 | 06 | f5 |
| 80 | 0b | ed | d2 | d7 | 9f | e5 | bf | a7 | 80 | 3a | bc | 2b | 42 | f4 | b0 | 70 |
| 90 | 19 | b2 | 61 | 15 | c0 | b0 | e6 | 61 | d2 | db | 3d | 1a | 96 | cc | 2b | 86 |
| a0 | d5 | ed | 99 | e9 | 70 | ce | b6 | 5f | 06 | 3b | ad | 34 | 7c | 16 | c4 | 0b |
| b0 | 2c | 66 | a0 | 62 | 50 | ef | 34 | 5a | 06 | 70 | 04 | c2 | a8 | a4 | 10 | b2 |
| c0 | 0f | 36 | 54 | 53 | 5a | c6 | 00 | 4a | fb | 02 | 0e | 85 | 03 | b2 | e3 | bc |
| d0 | 16 | 31 | ed | 30 | 2b | c8 | 35 | e5 | b9 | 3f | e3 | fe | ca | f2 | b5 | 60 |
| e0 | 2a | fa | 25 | 46 | c0 | 71 | b0 | 64 | 65 | 56 | 65 | 4e | e1 | ad | 56 | 52 |
| f0 | 8b | 46 | ac | 76 | b5 | df | 86 | 45 | 00 | 6e | 99 | 1b | e1 | 00 | 7e | 08 |
| e0 | 2a | fa | 25 | 46 | c0 | 71 | b0 | 64 | 65 | 56 | 65 | 4e | e1 | ad | 56 | 52 |
| f0 | 8b | 46 | ac | 76 | b5 | df | 86 | 45 | 00 | 6e | 99 | 1b | e1 | 00 | 7e | 08 |

viii. Inverted Substitution table 3021 is generated by the processor 1001 using the DSG 1005 and the DSG vectors 1004:

| | 00 | 01 | 02 | 03 | 04 | 05 | 06 | 07 | 08 | 09 | 0a | 0b | 0c | 0d | 0e | 0f |
|---|---|---|---|---|---|---|---|---|---|---|---|---|---|---|---|---|
| 00 | 9e | 2a | 92 | fe | 50 | b5 | 10 | 7f | 34 | b4 | e1 | de | b8 | c9 | 42 | d2 |
| 10 | b1 | 89 | e2 | c3 | 55 | ad | 20 | d3 | c8 | bb | 0a | 90 | d9 | 0d | 0f | b6 |
| 20 | ac | 96 | 37 | 26 | c6 | e5 | bf | 6f | 47 | 1b | 02 | 11 | 4e | d8 | 52 | 4a |
| 30 | ec | 07 | 3e | ae | 7a | 84 | e9 | 91 | 98 | 3a | 5a | e6 | 75 | f6 | 8e | 5d |
| 40 | ba | fa | 7e | a8 | 0b | 9d | 32 | ce | 41 | 6e | 9a | 8b | 39 | 33 | 57 | f8 |
| 50 | 88 | a0 | c4 | 8a | 40 | be | 1f | cc | da | 76 | 67 | ed | 7c | 2f | b0 | 3f |
| 60 | 3d | 44 | bc | fd | 08 | 97 | ca | f5 | 9c | b2 | 62 | 28 | 51 | 94 | 46 | 3b |
| 70 | 99 | 8c | ef | a2 | 5b | 4f | d6 | 73 | e3 | 9f | a6 | 12 | ee | f9 | 74 | 53 |
| 80 | 21 | c2 | 1a | 79 | b3 | 38 | 54 | 31 | d4 | 2c | f3 | f0 | a5 | e7 | eb | 3c |
| 90 | 1d | 13 | fc | 6d | cf | 35 | 6a | 23 | 5f | c1 | ea | c7 | 29 | 93 | 6c | 05 |
| a0 | 1e | 7b | 2e | 85 | 4d | a7 | 27 | 5c | 77 | 0c | fb | 15 | 14 | 24 | 87 | 22 |
| b0 | 78 | c0 | aa | 36 | 49 | d0 | 64 | a3 | 2b | cb | 4c | 2d | 5e | dd | 61 | e4 |
| c0 | 68 | 60 | 19 | 18 | d5 | 72 | db | ff | 4b | 8f | df | 82 | 80 | 6b | b7 | 70 |
| d0 | 95 | d1 | bd | 8d | ab | 81 | a4 | 04 | af | 65 | 66 | e0 | 17 | 30 | a9 | 69 |
| e0 | 7d | 43 | a1 | 63 | c5 | d7 | cd | 16 | 06 | 48 | f1 | 09 | e8 | 86 | 25 | 0e |
| f0 | f4 | 1c | 01 | dc | f2 | 58 | 00 | f7 | 45 | b9 | 83 | 71 | 03 | 56 | 59 | 9b |

ix. Internal working key 1006 is generated by the processor 1001 using the DSG 1005 and the DSG vectors 1004:

41 42 09 0e 75 4a 52 05 97 62

The same internal working key was used during the encryption process.

x. What follows is the step by step decryption process of the first bite of the encrypted text “83 e2 9a 1d d7 bb c8 01 dc 3a a4 26 e1” (hexadecimal) using Substitution/XOR/Subtraction processing order.
1) Encrypted value (byte) at the encrypted text data position 0=83 (hexadecimal)
2) Substitute value from position 83 of the substitution table 3021 to get value 79
3) To that value XOR the initial working key 1006 to provide the value 41 at position 00 to get value 38
4) From that value, subtract value e0 at position 00 of the subtractive table 3020 to get final value 58 or X
5) Repeat the above steps until the initial working key 1006 is exhausted and then generate a new working key when the current working key is exhausted.
6) The above 5 steps are repeated for each byte of the encrypted text data 1008 until the data is exhausted.

Stated differently, at step 1 of the decryption process as shown above, the byte to be processed is the data byte that is hexadecimal value 83. Next, at step 2, the position 83 in the substitution table 3021 returns a value of 79. At step 3, the value 79 from the step 2 is XOR'd with the initial working key 1006 to provide the value 41 from position 00, which results in a value of 38. Next, at step 4, the value e0 at position 00 of the subtractive table 3020 is subtracted from the value 38 from the previous step to get a final value 58 or X. A person skilled in the art will appreciate that the order of the substitution, XOR and subtraction operations can be altered at any time during the current decryption so long as such processing order is consistent with the processing order used during the encryption process.

The above steps are repeated until the internal working key 1006 is exhausted. Once the internal working key 1006 is exhausted, at step 5, a new working key is generated. The above 5 steps are repeated for each byte of the encrypted text 1008 until the encrypted text 1008 is decrypted into the original plaintext data 1003.

When multiple iterations of encryption are performed, the decryption process is performed as shown in the following example.

### Example 4

### Decryption Process

--------------------

### Initializing for Decryption

--------------------

### Iterations: 3

DSG seeds for demo are
DSG seed 1=1819145164
DSG seed 2=2133878803
DSG seed 3=578068005
DSG seed 4=1313382323
DSG seed 5=1542521175
DSG seed 6=1358903071
DSG seed 7=1373624615
DSG seed 8=634434395
Extracting IV from data stream
DSG vectors for demo are
DSG vector 1=2113407355
DSG vector 2=1737839646
DSG vector 3=1018411089
DSG vector 4=1447247159
DSG vector 5=1867667233
DSG vector 6=1973043051
DSG vector 7=1913358075
DSG vector 8=1149134690
DSG initialized and ready for use
Building Working key from supplied key
41 42 09 0e 75 4a 52 05 97 62

Inverted Decryption substitution table

| | 00 | 01 | 02 | 03 | 04 | 05 | 06 | 07 | 08 | 09 | 0a | 0b | 0c | 0d | 0e | 0f |
|---|---|---|---|---|---|---|---|---|---|---|---|---|---|---|---|---|
| 00 | 9e | 2a | 92 | fe | 50 | b5 | 10 | 7f | 34 | b4 | e1 | de | b8 | c9 | 42 | d2 |
| 10 | b1 | 89 | e2 | c3 | 55 | ad | 20 | d3 | c8 | bb | 0a | 90 | d9 | 0d | 0f | b6 |
| 20 | ac | 96 | 37 | 26 | c6 | e5 | bf | 6f | 47 | 1b | 02 | 11 | 4e | d8 | 52 | 4a |
| 30 | ec | 07 | 3e | ae | 7a | 84 | e9 | 91 | 98 | 3a | 5a | e6 | 75 | f6 | 8e | 5d |
| 40 | ba | fa | 7e | a8 | 0b | 9d | 32 | ce | 41 | 6e | 9a | 8b | 39 | 33 | 57 | f8 |
| 50 | 88 | a0 | c4 | 8a | 40 | be | 1f | cc | da | 76 | 67 | ed | 7c | 2f | b0 | 3f |
| 60 | 3d | 44 | bc | fd | 08 | 97 | ca | f5 | 9c | b2 | 62 | 28 | 51 | 94 | 46 | 3b |
| 70 | 99 | 8c | ef | a2 | 5b | 4f | d6 | 73 | e3 | 9f | a6 | 12 | ee | f9 | 74 | 53 |
| 80 | 21 | c2 | 1a | 79 | b3 | 38 | 54 | 31 | d4 | 2c | f3 | f0 | a5 | e7 | eb | 3c |
| 90 | 1d | 13 | fc | 6d | cf | 35 | 6a | 23 | 5f | c1 | ea | c7 | 29 | 93 | 6c | 05 |
| a0 | 1e | 7b | 2e | 85 | 4d | a7 | 27 | 5c | 77 | 0c | fb | 15 | 14 | 24 | 87 | 22 |
| b0 | 78 | c0 | aa | 36 | 49 | d0 | 64 | a3 | 2b | cb | 4c | 2d | 5e | dd | 61 | e4 |
| c0 | 68 | 60 | 19 | 18 | d5 | 72 | db | ff | 4b | 8f | df | 82 | 80 | 6b | b7 | 70 |
| d0 | 95 | d1 | bd | 8d | ab | 81 | a4 | 04 | af | 65 | 66 | e0 | 17 | 30 | a9 | 69 |
| e0 | 7d | 43 | a1 | 63 | c5 | d7 | cd | 16 | 06 | 48 | f1 | 09 | e8 | 86 | 25 | 0e |
| f0 | f4 | 1c | 01 | dc | f2 | 58 | 00 | f7 | 45 | b9 | 83 | 71 | 03 | 56 | 59 | 9b |

Decryption subtractive (additive) table

| | 00 | 01 | 02 | 03 | 04 | 05 | 06 | 07 | 08 | 09 | 0a | 0b | 0c | 0d | 0e | 0f |
|---|---|---|---|---|---|---|---|---|---|---|---|---|---|---|---|---|
| 00 | e0 | 74 | 6f | 9a | 0e | 47 | c9 | bd | 11 | d5 | ca | 11 | f3 | d1 | 07 | 6f |
| 10 | 40 | 3c | 04 | 88 | 3b | 4c | 97 | 03 | 1a | 12 | 0f | dd | 8c | c7 | a6 | 2e |
| 20 | a8 | 67 | 55 | e6 | 14 | 5d | a0 | 18 | 43 | cc | 5f | 13 | dc | 61 | fa | 05 |
| 30 | 61 | 94 | be | 7f | 91 | 1e | b1 | 93 | db | 6c | 80 | fa | 37 | eb | 31 | 49 |
| 40 | 2f | 9c | 68 | 8c | 7c | 20 | 5b | e1 | 9b | eb | 45 | 6e | ec | 84 | 26 | b8 |
| 50 | 17 | 09 | 7b | f6 | 08 | 27 | 9b | 89 | b4 | c0 | 0a | a7 | db | a5 | df | 57 |
| 60 | 9b | 15 | e3 | 3f | f8 | 6e | 88 | 41 | 39 | db | e3 | a5 | d7 | 43 | a6 | 57 |
| 70 | 46 | c6 | e3 | 2e | 6f | 39 | 41 | 08 | 01 | dd | d7 | ba | 15 | b2 | 06 | f5 |
| 80 | 0b | ed | d2 | d7 | 9f | e5 | bf | a7 | 80 | 3a | bc | 2b | 42 | f4 | b0 | 70 |
| 90 | 19 | b2 | 61 | 15 | c0 | b0 | e6 | 61 | d2 | db | 3d | 1a | 96 | cc | 2b | 86 |
| a0 | d5 | ed | 99 | e9 | 70 | ce | b6 | 5f | 06 | 3b | ad | 34 | 7c | 16 | c4 | 0b |
| b0 | 2c | 66 | a0 | 62 | 50 | ef | 34 | 5a | 06 | 70 | 04 | c2 | a8 | a4 | 10 | b2 |
| c0 | 0f | 36 | 54 | 53 | 5a | c6 | 00 | 4a | fb | 02 | 0e | 85 | 03 | b2 | e3 | bc |
| d0 | 16 | 31 | ed | 30 | 2b | c8 | 35 | e5 | b9 | 3f | e3 | fe | ca | f2 | b5 | 60 |
| e0 | 2a | fa | 25 | 46 | c0 | 71 | b0 | 64 | 65 | 56 | 65 | 4e | e1 | ad | 56 | 52 |
| f0 | 8b | 46 | ac | 76 | b5 | df | 86 | 45 | 00 | 6e | 99 | 1b | e1 | 00 | 7e | 08 |

--------------------
Encrypted data
47 6a 9e 45 a7 34 3e 17 0f 1a 2b d5 4f
--------------------
--------------------

### Decrypting

--------------------
Encrypted byte->swap with subst->xor with key->subtract=original byte
Pass: 01 Encrypted value (byte) at data position 0=47->Substitute value from position 47 to get value ce->Xor key value 00 at position 41 to get value 8f->Subtract previous value e0 from subtractive position 00 to get final value af
Pass: 02 Encrypted value (byte) at data position 0=af->Substitute value from position af to get value 22->Xor key value 00 at position 41 to get value 63->Subtract previous value e0 from subtractive position 00 to get final value 83
Pass: 03 Encrypted value (byte) at data position 0=83->Substitute value from position 83 to get value 79->Xor key value 00 at position 41 to get value 38->Subtract value e0 from subtractive position 00 to get final value 58 or X
Pass: 01 Encrypted value (byte) at data position 1=6a->Substitute value from position 6a to get value 62->Xor key value 01 at position 42 to get value 20->Subtract previous value 74 from subtractive position 01 to get final value ac
Pass: 02 Encrypted value (byte) at data position 1=ac->Substitute value from position ac to get value 14->Xor key value 01 at position 42 to get value 56->Subtract previous value 74 from subtractive position 01 to get final value e2
Pass: 03 Encrypted value (byte) at data position 1=e2->Substitute value from position e2 to get value a1->Xor key value 01 at position 42 to get value e3->Subtract value 74 from subtractive position 01 to get final value 6f or o
Pass: 01 Encrypted value (byte) at data position 2=9e->Substitute value from position 9e to get value 6c->Xor key value 02 at position 09 to get value 65->Subtract previous value 6f from subtractive position 02 to get final value f6
Pass: 02 Encrypted value (byte) at data position 2=f6->Substitute value from position f6 to get value 00->Xor key value 02 at position 09 to get value 09->Subtract previous value 6f from subtractive position 02 to get final value 9a
Pass: 03 Encrypted value (byte) at data position 2=9a->Substitute value from position 9a to get value ea->Xor key value 02 at position 09 to get value e3->Subtract value 6f from subtractive position 02 to get final value 74 or t
Pass: 01 Encrypted value (byte) at data position 3=45->Substitute value from position 45 to get value 9d->Xor key value 03 at position 0e to get value 93->Subtract previous value 9a from subtractive position 03 to get final value f9
Pass: 02 Encrypted value (byte) at data position 3=f9->Substitute value from position f9 to get value b9->Xor key value 03 at position 0e to get value b7->Subtract previous value 9a from subtractive position 03 to get final value 1d
Pass: 03 Encrypted value (byte) at data position 3=1d->Substitute value from position 1d to get value 0d->Xor key value 03 at position 0e to get value 03->Subtract value 9a from subtractive position 03 to get final value 69 or i
Pass: 01 Encrypted value (byte) at data position 4=a7->Substitute value from position a7 to get value 5c->Xor key value 04 at position 75 to get value 29->Subtract previous value 0e from subtractive position 04 to get final value 1b
Pass: 02 Encrypted value (byte) at data position 4=1b->Substitute value from position 1b to get value 90->Xor key value 04 at position 75 to get value e5->Subtract previous value 0e from subtractive position 04 to get final value d7
Pass: 03 Encrypted value (byte) at data position 4=d7->Substitute value from position d7 to get value 04->Xor key value 04 at position 75 to get value 71->Subtract value 0e from subtractive position 04 to get final value 63 or c
Pass: 01 Encrypted value (byte) at data position 5=34->Substitute value from position 34 to get value 7a->Xor key value 05 at position 4a to get value 30->Subtract previous value 47 from subtractive position 05 to get final value e9
Pass: 02 Encrypted value (byte) at data position 5=e9->Substitute value from position e9 to get value 48->Xor key value 05 at position 4a to get value 02->Subtract previous value 47 from subtractive position 05 to get final value bb
Pass: 03 Encrypted value (byte) at data position 5=bb->Substitute value from position bb to get value 2d->Xor key value 05 at position 4a to get value 67->Subtract value 47 from subtractive position 05 to get final value 20 or
Pass: 01 Encrypted value (byte) at data position 6=3e->Substitute value from position 3e to get value 8e->Xor key value 06 at position 52 to get value dc->Subtract previous value c9 from subtractive position 06 to get final value 13
Pass: 02 Encrypted value (byte) at data position 6=13->Substitute value from position 13 to get value c3->Xor key value 06 at position 52 to get value 91->Subtract previous value c9 from subtractive position 06 to get final value c8
Pass: 03 Encrypted value (byte) at data position 6=c8->Substitute value from position c8 to get value 4b->Xor key value 06 at position 52 to get value 19->Subtract value c9 from subtractive position 06 to get final value 50 or P
Pass: 01 Encrypted value (byte) at data position 7=17->Substitute value from position 17 to get value d3->Xor key value 07 at position 05 to get value d6->Subtract previous value bd from subtractive position 07 to get final value 19
Pass: 02 Encrypted value (byte) at data position 7=19->Substitute value from position 19 to get value bb->Xor key value 07 at position 05 to get value be->Subtract previous value bd from subtractive position 07 to get final value 01
Pass: 03 Encrypted value (byte) at data position 7=01->Substitute value from position 01 to get value 2a->Xor key value 07 at position 05 to get value 2f->Subtract value bd from subtractive position 07 to get final value 72 or r
Pass: 01 Encrypted value (byte) at data position 8=0f->Substitute value from position 0f to get value d2->Xor key value 08 at position 97 to get value 45->Subtract previous value 11 from subtractive position 08 to get final value 34
Pass: 02 Encrypted value (byte) at data position 8=34->Substitute value from position 34 to get value 7a->Xor key value 08 at position 97 to get value ed->Subtract previous value 11 from subtractive position 08 to get final value dc
Pass: 03 Encrypted value (byte) at data position 8=dc->Substitute value from position dc to get value 17->Xor key value 08 at position 97 to get value 80->Subtract value 11 from subtractive position 08 to get final value 6f or o
Pass: 01 Encrypted value (byte) at data position 9=1a->Substitute value from position 1a to get value 0a->Xor key value 09 at position 62 to get value 68->Subtract previous value d5 from subtractive position 09 to get final value 93
Pass: 02 Encrypted value (byte) at data position 9=93->Substitute value from position 93 to get value 6d->Xor key value 09 at position 62 to get value 0f->Subtract previous value d5 from subtractive position 09 to get final value 3a
Pass: 03 Encrypted value (byte) at data position 9=3a->Substitute value from position 3a to get value 5a->Xor key value 09 at position 62 to get value 38->Subtract value d5 from subtractive position 09 to get final value 63 or c
Key exhausted.

### Generating new key

New key generated
key=62 3b 25 f0 a8 ac 4b 43 97 be
Pass: 01 Encrypted value (byte) at data position 10=2b->Substitute value from position 2b to get value 11->Xor key value 00 at position 62 to get value 73->Subtract previous value ca from subtractive position 0a to get final value a9
Pass: 02 Encrypted value (byte) at data position 10=a9->Substitute value from position a9 to get value 0c->Xor key value 00 at position 62 to get value 6e->Subtract previous value ca from subtractive position 0a to get final value a4
Pass: 03 Encrypted value (byte) at data position 10=a4->Substitute value from position a4 to get value 4d->Xor key value 00 at position 62 to get value 2f->Subtract value ca from subtractive position 0a to get final value 65 or e
Pass: 01 Encrypted value (byte) at data position 11=d5->Substitute value from position d5 to get value 81->Xor key value 01 at position 3b to get value ba->Subtract previous value 11 from subtractive position 0b to get final value a9
Pass: 02 Encrypted value (byte) at data position 11=a9->Substitute value from position a9 to get value 0c->Xor key value 01 at position 3b to get value 37->Subtract previous value 11 from subtractive position 0b to get final value 26
Pass: 03 Encrypted value (byte) at data position 11=26->Substitute value from position 26 to get value bf->Xor key value 01 at position 3b to get value 84->Subtract value 11 from subtractive position 0b to get final value 73 or s
Pass: 01 Encrypted value (byte) at data position 12=4f->Substitute value from position 4f to get value f8->Xor key value 02 at position 25 to get value dd->Subtract previous value f3 from subtractive position 0c to get final value ea
Pass: 02 Encrypted value (byte) at data position 12=ea->Substitute value from position ea to get value f1->Xor key value 02 at position 25 to get value d4->Subtract previous value f3 from subtractive position 0c to get final value e1
Pass: 03 Encrypted value (byte) at data position 12=e1->Substitute value from position e1 to get value 43->Xor key value 02 at position 25 to get value 66->Subtract value f3 from subtractive position 0c to get final value 73 or s
--------------------
Decrypted data
58 6f 74 69 63 20 50 72 6f 63 65 73 73
--------------------
Decrypting done

### Comparing

### Decrypted=Original

Iteration count=3, time=3022 ticks

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims. Various aspects of the systems, methods, functions, steps, features and the like corresponding thereto disclosed herein may be implemented on one or more computer systems using hardware, software, firmware, circuits, or combinations thereof. Hardware, software, firmware, and circuits respectively refer to any hardware, software, firmware, or circuit component. Computer systems referred to herein may refer to any computing device and vice versa (e.g., smart phone, mobile computing device, personal data assistant, tablet computer, laptop computer, desktop computer, other computing device, and the like). For example, each computer system or computing device in the systems described herein or any embodiment of a system disclosed herein may utilize one or more of the following components: a single-core or multi-core hardware processor (e.g., central processing unit or graphics processing unit) on which software instructions are executed (e.g., instructions corresponding to an operating system, an application program, an interpreter such as a virtual machine, or a compiler); a memory associated with and in connection with the hardware processor such as cache or other system memory that stores software instructions or other data that the hardware processor may access for processing; an input device (e.g., mouse, keyboard, touchscreen, and the like); an output device (e.g., display, touchscreen, printer, and the like); a network or communication interface that enables the computer system to communicate over a network or communication protocol; an application program having corresponding software instructions that are executable by a hardware processor. Connections between different computer systems and connections between different computer system components may be wired or wireless.

Virtualization computing techniques, cloud computing techniques, web application/website computing techniques, traditional and adaptive streaming techniques, and other computing techniques may be implemented by any embodiment of a system disclosed herein to enable and/or enhance the teachings described herein. For example, in a cloud computing embodiment, one or more servers (i.e., one or more computer systems) may store and execute software instructions corresponding to an application program based on input data received from client devices. In response to the input data received, the application program is executed accordingly, which results in graphical data being processed and output to the client devices for display on a display such as a touch screen on a smart phone or tablet computer.

As another example, in a web application or website embodiment, data representative of a user input may be transmitted to a server (i.e., a computer system) hosting the website for processing and storage in memory. In an application program embodiment, the application may be stored and executed locally on a user's computer system. In other embodiments, one or more components of the application program may be stored and executed on a server and the user's computer system. For example, a user may download the application program from an app store for an Android computing device, Blackberry computing device, Apple computing device, Windows computing device, Samsung computing device, other computing device, and the like. Execution of the application program on the user's computing device may require that the device transmit and receive data to and from one or more computing devices such as a server or other user's computing device. For example, an application may be downloaded from a server to a mobile device. Upon installation, the mobile device may communicate with a server.

One or more embodiments of the systems disclosed herein may utilize streaming technology. Streaming data enables data to be presented to the user of the client device while the client device receives data from the server. Streaming data from servers to client devices (e.g., computing devices operated by users) over a network is typically limited by the bandwidth of the network, or alternatively, the physical layer net bitrate. Traditional streaming protocols, such as RTSP (Real-Time Streaming Protocol), MS-WMSP (Windows Media HTTP Streaming Protocol), and RTMP (Real-Time Messaging Protocol) may be implemented, which essentially send data in small packets from the server to the client device in real-time at the encoded bitrate of the data. Adaptive streaming may also be implemented. Adaptive streaming almost exclusively relies on HTTP for the transport protocol. Similar to traditional streaming, data is encoded into discrete packets of a particular size; however, the source data is encoded at multiple bitrates rather than a single bitrate. The data packets corresponding to the same data encoded at different bitrates are then indexed based on the bitrate in memory. This streaming method works by measuring, in real-time, the available bandwidth and computer capacity of the client device, and adjusts which indexed data packet to transfer based on the encoded bitrate.

One or more aspects of the systems disclosed herein may be located on (i.e., processed, stored, executed, or the like; or include one or more hardware or software components) a single computer system or may be distributed among a plurality of computer systems attached by one or more communication networks (e.g., internet, intranet, a telecommunications network, and the like). One or more components of a computer system may be distributed across one or more computer systems in communication with the computer system over a communication network. For example, in some embodiments, the systems disclosed herein may utilize one or more servers (i.e., one or more computer systems dedicated for a particular purpose in the system) that may be dedicated to serve the needs of one or more other computer systems or components across a communication network and/or system bus. The one or more servers may provide a central processing location for one or more aspects of the systems disclosed herein.

Again, various aspects of the systems, methods, function, and steps corresponding thereto disclosed herein may be implemented on one or more computer systems using hardware, software, firmware, or combinations thereof. Those of ordinary skill in the art will appreciate that one or more circuits and/or software may be used to implement the system and methods described herein. Circuits refer to any circuit, whether integrated or external to a processing unit such as a hardware processor. Software refers to code or instructions executable by a computing device using any hardware component such as a processor to achieve the desired result. This software may be stored locally on a processing unit or stored remotely and accessed over a communication network.

As disclosed herein, a processor or hardware processor may refer to any hardware processor or software processor. A software processor may include or otherwise constitute an interpreter that is executed by a corresponding hardware processor. A computer system according to any embodiment disclosed herein is configured to perform any of the described functions related to the various embodiments of the systems disclosed herein.

As disclosed herein, any method, function, step, feature, or result may be considered a module that may include software instructions that cause, when executed by a computing device, the desired method, function, step, feature, or result. Executed by a computing device includes execution by any hardware component (e.g., CPU, GPU, network interface, integrated circuits, other hardware components, and the like) of the computing device such as a hardware processor. Any module may be executed by a computing device (e.g., by a processor of the computing device). Any method, function, step, feature, result, and the like disclosed herein may be implemented by one or more software modules whether explicitly described or not. Individual components within a computing device may work together to accomplish a desired method, function, step, feature, or result. For example, a computing device may receive data and process the data. A simple example would be that a network interface receives the data and transmits the data over a bus to a processor.

Various aspects of the systems disclosed herein may be implemented as software executing in a computer system. The computer system may include a central processing unit (i.e., a hardware processor) connected to one or more memory devices, a graphical processing unit, input devices such as a mouse and keyboard, output devices such as speakers and a display, a network interface to connect to one or more other computer systems (e.g., one or more computer systems configured to provide a service such that function as a database), an operating system, a compiler, an interpreter (i.e., a virtual machine), and the like. The memory may be used to store executable programs and data during operation of the computer system. The executable programs may be written in a high-level computer programming language, such as Java or C++. Of course, other programming languages may be used since this disclosure is not limited to a specific programming language or computer system. Further, it is to be appreciated that the systems and methods disclosed herein are not limited to being executed on any particular computer system or group of computer systems.

Some methods, functions, steps, or features have been described as being executed by corresponding software by a processor. It is understood than any methods, functions, steps, features, or anything related to the systems disclosed herein may be implemented by hardware, software (e.g., firmware), or circuits despite certain methods, functions, steps, or features having been described herein with reference to software corresponding thereto that is executable by a processor to achieve the desired method, function, or step. It is understood that software instructions may reside on a non-transitory medium such as one or more memories accessible to one or more processors in the systems disclosed herein. For example, where a computing device receives data, it is understood that the computing device processes that data whether processing the data is affirmatively stated or not. Processing the data may include storing the received data, analysing the received data, and/or processing the data to achieve the desired result, function, method, or step. It is further understood that input data from one computing device or system may be considered output data from another computing device or system, and vice versa. It is yet further understood that any methods, functions, steps, features, results, or anything related to the systems disclosed herein may be represented by data that may be stored on one or more memories, processed by one or more computing devices, received by one or more computing devices, transmitted by one or more computing devices, and the like.

The various embodiments and examples described herein are provided by way of illustration only and should not be construed to limit the claimed invention, nor the scope of the various embodiments and examples. Those skilled in the art will readily recognize various modifications and changes that may be made to the claimed invention without following the example embodiments and applications illustrated and described herein, and without departing from the true spirit and scope of the claimed invention, which is set forth in the following claims. In addition, various embodiments may be combined. Therefore, reference to an embodiment, one embodiment, in some embodiments, in other embodiments, and the like does not preclude one or more methods, functions, steps, features, results, hardware implementations, or software implementations of different embodiments from being combined. Further, reference to an embodiment, one embodiment, in some embodiments, in other embodiments, examples, and the like provides various aspects that may or may not be combined with those of one or more different embodiments and/or examples.

1. A method for encrypting data, comprising:
using a processor to:
access plaintext to be encrypted;
access a random value;
access a set of Deterministic Sequence Generator (DSG) seeds;
access a user key;
mathematically process the random value and the set of DSG seeds to generate an initialization value;
mathematically process the initialization value and the user key to generate a set of initial DSG vectors;
input the set of initial DSG vectors into a DSG to generate an additive table, a substitution table and a first working key;
process the plaintext into encrypted data, using the additive table, the substitution table and the working key, by performing:
a) an addition operation on each byte of data using the additive table;
b) an XOR operation on each byte;
c) a substitution operation on each byte of data using the substitution table, and
d) generating a new working key when the current working key is exhausted.

2. The method for encrypting data of claim 1, wherein the method further comprises:
repeating, using the processor, steps (a-d) until the plaintext data is completely encrypted.

3. The method for encrypting data of claim 1, wherein the method further comprises:
accessing, using the processor and a memory device and/or interface, at least a second random value.

4. The method for encrypting data of claim 1, wherein the length of the first working key and the new working keys are at least twice the length of the user key.

5. The method for encrypting data of claim 1, wherein the order of the addition, XOR and substitution operations, as performed by the processor, are altered during the encryption of the plaintext data.

6. The method for encrypting data of claim 1, wherein the processor processes the plaintext data into encrypted data using a plurality of encryption iterations.

7. The method for encrypting data of claim 1, wherein each of the additive table and the substitution table comprises 256 random numbers.

8. The method for encrypting data of claim 7, wherein the additive table has repeated values.

9. The method for encrypting data of claim 1, wherein each of the DSG seeds is a random number.

10. The method for encrypting data of claim 1, wherein each of the DSG seeds is mathematically congruent to the formulas and algorithms used in the DSG.

11. The method for encrypting data of claim 1, wherein the DSG shuffles 256 times during the generation of each of the additive table and the substitution table.

12. A method for decrypting data, comprising:
using a processor to:
access from a memory an encrypted text to be decrypted;
access from the memory a random value;
access from the memory a set of Deterministic Sequence Generator (DSG) seeds;
access from the memory a user key;
mathematically process the random value and the set of DSG seeds to generate an initialization value;
mathematically process the initialization value and the user key to generate a set of initial DSG vectors;
input the set of initial DSG vectors into a DSG to generate a subtractive table, an inverted substitution table and a first working key;
process the encrypted text into decrypted data, using the subtractive table, the inverted substitution table and the working key, by performing:
a) a substitution operation on each byte of data using the inverted substitution table;
b) an XOR operation on each byte;
c) a subtraction operation on each byte of data using the subtractive table, and
d) generating a new working key when the current working key is exhausted.

13. The method for encrypting data of claim 12, wherein the processor repeats steps (a-d) until the encrypted text is completely decrypted into plaintext data.

14. The method for decrypting data of claim 12, wherein the method comprises:
accessing the initialization value as opposed to regenerating the initialization value.

15. The method for decrypting data of claim 12, wherein the method further comprises:
accessing, using the processor, a memory device and an interface, at least a second random value.

16. The method for decrypting data of claim 12, wherein the length of the first working key and the new working keys are at least twice the length of the user key.

17. The method for decrypting data of claim 12, wherein the order of the substitution, XOR and subtraction operations, as performed by the processor, are altered during the decryption of the encrypted text.

18. The method for decrypting data of claim 12, wherein the processor processes the encrypted text into decrypted data using a plurality of decryption iterations.

19. The method for decrypting data of claim 12, wherein each of the subtractive table and the inverted substitution table comprises 256 random numbers.

20. The method for encrypting data of claim 19, wherein the subtractive table has repeated values.

21. A system for encrypting data, comprising:
a processor, the processor in communication with a user interface and a memory;
the processor configured to access a set of Deterministic Sequence Generator (DSG) seeds, a random value and a user key;
the user interface configured to receive a plaintext data to be encrypted;
the processor communicating with the memory to store in the memory a DSG;
the processor configured to mathematically process the random value and the set of DSG seeds to generate an initialization value;
the processor configured to mathematically process the initialization value and the user key to generate a set of initial DSG vectors;
the processor communicating with the memory to store in the memory the set of initial DSG vectors;
the DSG communicating with the processor to access the set of initial DSG vectors to generate an additive table and a substitution table using the set of initial DSG vectors;
the DSG communicating with the processor to access the set of initial DSG vectors and the user key to generate a working key using the set of initial DSG vectors and the user key;
the processor communicating with the memory to store in the memory the additive table, the substitution table and the first working key;
the processor further configured to process the plaintext into encrypted data, using the additive table, the substitution table and the working key, by performing:
a) an addition operation on each byte using the additive table;
b) an XOR operation on each byte;
c) a substitution operation using the substitution table, and
d) generating a new working key when the current working key is exhausted.

22. The system for encrypting data of claim 21, wherein the processor repeats steps (a-d) until the plaintext data is completely encrypted.
